(19) United States
(12) Patent Application Publication
(10) Pub. No.: US 2003/0057721 A1
(43) Pub. Date: Mar. 27, 2003

(54) Auxiliary handle for long-handled implements

(76) Inventor: Paul Ducklow, Sheboygan, WI (US)

Correspondence Address: MEDLEN & CARROLL, LLP, Suite 350, 101 Howard Street, San Francisco, CA, 94105, US

(21) Appl. No.: 10/222,148

(22) Filed: Aug. 16, 2002

Related U.S. Application Data
(60) Provisional application No. 60/312,850, filed on Aug. 16, 2001.
(60) Provisional application No. 60/396,086, filed on Jul. 16, 2002.

(51) Int. Cl. A01B 1/22; B25G 3/00

(52) U.S. Cl. 294/58

(57) ABSTRACT

The present invention relates to auxiliary handles for long-handled implements used to manually move or manipulate materials, such as shovels and pitchforks, and in particular to an improved detachable auxiliary handle which enables use of an implement without twisting and thus decreases back strain and back injury. The auxiliary handle comprises an angled frame, of which the first member or leg is a handle member and of which the second member or leg is a brace member. One end of the handle member is the free end, which is grasped by the user's hand, and may further comprise a hand grip; the other end of the handle member comprises a clamp which is attached to the implement handle nearer the shovel or fork end. One end of the brace member is attached to the handle member near the free end, to form an angle with the brace member; the other end of the brace member comprises a clamp that is attached to the implement handle nearer the free end.

The present application claims priority from provisional applications Serial Nos. 60/312,850, filed Aug. 16, 2001, and 60/396,086, filed Jul. 16, 2002.

### FIELD OF THE INVENTION

The present invention relates to auxiliary handles for long-handled implements used to manually move or manipulate materials, such as shovels and pitchforks, and in particular to an improved detachable auxiliary handle which enables use of an implement without stooping and/or twisting and thus decreasing the risk of back strain and back injury, and which also provides increased leverage and control.

### BACKGROUND OF THE INVENTION.

Conventional manual material-moving implements, such as shovels and pitchforks, typically comprise a material-engaging scoop or fork with a long handle shaft rigidly affixed to it at one end of the shaft, while the other end of the handle shaft, the free end, serves as a handle, and frequently comprises a hand grip. The user of such an implement normally holds the implement by grasping with one hand the handle portion of the handle shaft and by grasping with the other hand the long handle shaft nearer the scoop or fork, and then moving or lifting the implement. The user typically moves such an implement by pushing it along the ground or under or into material to be moved while walking in an upright or semi-upright position. When the scoop or fork has engaged the material, the user shifts position to one side of the implement and bends over and grasps the handle shaft with one hand at the handle end and with the other hand at a location fairly close to the scoop or fork in order to obtain sufficient leverage to lift and move the material, thus assuming a stooped position. By pulling the lower section of the handle shaft upwardly, the user then raises the scoop or fork. If the user then tosses the material on it to one side or the other, the body is twisted laterally.

This stooping, lifting, and twisting generally causes back strain and frequently causes back injuries, such as pulled muscles and herniated or bulging discs in the spine. The mechanics of moving material with such an implement are improved if, instead of a user reaching and grasping the handle shaft near the blade or fork end, the user grasps an auxiliary handle which is raised vertically by at least several inches from the handle shaft and is closer to the free or handle end of the shaft yet which still creates the leverage necessary to lift the scoop or fork. The higher the auxiliary handle is relative to the ground, the less the user will have stoop to grasp the handle and the fewer and less severe the back problems the user will experience as a result. Moreover, provision of an auxiliary handle inhibits the user from tossing material to one side or the other, and instead entrains the user to tossing the material substantially forward or to the front of the user. Both the improved mechanics and the change in discharge of material from using an auxiliary handle result in a decreased risk back strain and associated injuries.

The provision of auxiliary handles for conventional long-handled implements for minimizing back strain problems has been described previously. However, these auxiliary handles are often complex and contain numerous moving parts, including hinges, pivots, swivels, and telescoping members. Although these many parts are provided for adjusting the handle to the user, the result is that they are cumbersome and not simple to use. They also have parts that can get lost easily, and they are not sufficiently strong to provide adequate leverage for digging into hard material such as icy snow, ground, or compacted hay. Moreover, auxiliary handles capable of being attached to long-handled implements are not currently commercially available, presumably either because of manufacturing difficulties or because of difficulties in using them, such as might be encountered in attaching or detaching an auxiliary handle or using it for digging into hard materials.

What is needed is an auxiliary handle that is simple to use, has few moving parts, has parts which cannot get easily separated and lost, can be conveniently attached to and easily adjusted along the handle shaft of the implement to accommodate the reach of different users, and which is strong enough to dig into hard materials.

### SUMMARY OF THE INVENTION

It is an object of the present invention to provide a detachable auxiliary handle for a long-handled manual material-moving implement which does not require the user to stoop much when using the implement, because the auxiliary handle is closer to the user, both along the handle shaft and above the handle shaft.

It is another objective of the present invention is to provide a detachable auxiliary handle for a long-handled manual material-moving implement which substantially reduces the risk of back strain or injury to the user, problems usually associated with the user having to stoop while using the implement without the auxiliary handle.

Yet another object of the present invention is to provide a detachable auxiliary handle for a long-handled manual material-moving implement which can be conveniently attached to and easily adjusted along the handle shaft of the implement to accommodate the reach of different users.

It is yet another object of the present invention to provide a detachable auxiliary handle for a long-handled manual material-moving implement which is simple to use and which has few moving parts, and which is easily attached to and detached from the long handle shaft of the implement.

It is yet a further object of the present invention to provide a detachable auxiliary handle which has parts which cannot get easily separated and lost.

It is yet a further object of the present invention to provide a detachable auxiliary handle which when attached to the long handle shaft provides sufficient strength to allow the user to dig the implement into hard materials.

It is yet another object of the present invention to provide an auxiliary handle for long-handled implements which is easy and economical to manufacture.

These objects and more are met by the present invention which provides in one aspect a detachable auxiliary handle for a long-handled manual material-moving implement which comprises an angled frame; the frame comprises two members, or legs, of which the first leg is nearer to the user when the auxiliary handle is attached to the implement, and of which the second leg is nearer to the material moving end of the implement when the auxiliary handle is attached to the implement. The two legs of the frame form an angle of about 45 degrees, although other angles are contemplated; a first end of each leg is in contact with the implement handle, whereas the second end of one leg is attached to the other leg at a distance slightly below the second end of the other leg to form the angle, such that the second end of the other leg extends beyond the angle to form a free end or handle end. Thus, depending upon the configuration, the second end of either leg may form a free end or handle end. When attached to the implement handle, the first leg is about perpendicular to the implement handle.

In some embodiments, the second end of the second leg is a free end or handle end; in this embodiment, the first leg is a brace member, and the second leg is a handle member. In this embodiment, the second end of the handle member is the free end, which is grasped by the user's hand, and may further comprise a hand grip; the first end of the handle member is contacted to the implement handle nearer the shovel or fork end. The second end of the brace member is attached to the handle member near the free end, to form an angle with the handle member; the first end of the brace member is contacted to the implement handle nearer the user end.

In other embodiments, the first leg is a handle member, and the second leg is a brace member. In this other embodiment, the second end of the handle member is a free end, which is grasped by the user's hand, and may further comprise a hand grip; the first end of the handle member is contacted to the implement handle nearer the user end. The second end of the brace member is attached to the handle member near the free end, to form an angle with the handle member; the first end of the brace member is contacted to the implement handle nearer the shovel or fork end.

Thus, the present invention provides a detachable auxiliary handle for use with a long-handled manual material moving implement comprising: a handle leg member having a first end and a second end, wherein the first end comprises means to contact the handle leg member to a handle shaft of a the implement and wherein the second end is a free end; and a brace leg member having a first end and a second end, wherein the first end comprises means to contact the brace leg member to the handle shaft of the implement such that the brace leg member is approximately perpendicular to the handle shaft, and wherein the second end is fixedly attached to the handle leg member slightly down from the free end of the handle member to form an approximately 45 degree angle with the handle leg member. In some embodiments, the handle leg member further comprises a hand grip on the free end. The auxiliary handle further comprises means to detachably attach the auxiliary handle to the implement handle shaft; such means are described further below.

The present invention also provides a detachable auxiliary handle for use with a long-handled manual material moving implement comprising: a handle leg member having a first end and a second end, wherein the first end comprises means to contact the handle leg member to a handle shaft of a the implement such that the handle leg member is approximately perpendicular to the handle shaft and wherein the second end is a free end; and a brace leg member having a first end and a second end, wherein the first end comprises means to contact the brace leg member to the handle shaft of the implement, and wherein the second end is fixedly attached to the handle leg member slightly down from the free end of the handle member to form an approximately 45 degree angle with the handle leg member. In some embodiments, the handle leg member further comprises a hand grip on the free end. The auxiliary handle further comprises means to detachably attach the auxiliary handle to the implement handle shaft; such means are described further below.

In another aspect, the present invention provides a detachable auxiliary handle for a long-handled manual material-moving implement which comprises an angled frame; the frame comprises two members, or legs, of which the first leg is nearer to the user when the auxiliary handle is attached to the implement, and of which the second leg is nearer to the material moving end of the implement when the auxiliary handle is attached to the implement. In this aspect of the present invention, the two legs of the frame form an angle of about 45 degrees, although other angles are contemplated; a first end of each leg is in contact with the implement handle, whereas the second end of one leg is attached to the second end of the other leg to form the angle in the intersection of the two legs. In this embodiment, neither leg extends past the other to form a free end or handle end. When attached to the implement handle, the first leg is about perpendicular to the implement handle. In this aspect, a hand grip is attached to the auxiliary handle at the intersection of the two legs. The auxiliary handle further comprises means to detachably attach the auxiliary handle to the implement handle shaft; such means are described further below.

In yet another aspect, the present invention provides a detachable auxiliary handle for a long-handled manual material-moving implement which comprises an arched frame, where the frame comprises a single member, or leg, of which a first end is nearer to the user when the auxiliary handle is attached to the implement, and of which a second end is nearer to the material moving end of the implement when the auxiliary handle is attached to the implement. In this aspect of the present invention, the first end and the second end of the leg are in contact with the implement handle. In this aspect, a hand grip is attached to the auxiliary handle at the high point of the arch. The auxiliary handle further comprises means to detachably attach the auxiliary handle to the implement handle shaft; such means are described further below.

In yet another aspect, the present invention provides a detachable auxiliary handle for a long-handled manual material-moving implement which comprises an arched frame, where the frame comprises two members, or legs, of which the first leg is nearer to the user when the auxiliary handle is attached to the implement, and of which the second leg is nearer to the material moving end of the implement when the auxiliary handle is attached to the implement. In this aspect of the present invention, the two legs of the frame form an angle of about 45 degrees, although other angles are contemplated; a first end of each leg is in contact with the implement handle, whereas the second end of one leg is attached to the second end of the other leg to form the angle in the intersection of the two legs. In this embodiment, neither leg extends past the other to form a free end or handle end. In this embodiment, at least one leg is curved to form an arched frame; in particular embodiments, the second leg is curved. When attached to the implement handle, the first leg is about perpendicular to the implement handle. In this aspect, a hand grip is attached to the auxiliary handle at the intersection of the two legs. The auxiliary handle further comprises means to detachably attach the auxiliary handle to the implement handle shaft; such means are described further below.

In further embodiments, means to detachably attach any auxiliary handle as described above to the implement handle shaft comprise clamps, where the clamps are the means to contact the first end of the handle leg member and the means to contact the first end of the brace leg member to the handle shaft of an implement. In some embodiments, a clamp comprises two main components, an upper clamp housing and a lower damper bar, wherein the two components of the clamp are fastened with bolts. In some further embodiments, the lower damper bar comprises means by which the damper bar can be pivoted around one bolt while a second bolt remains in place, allowing the auxiliary handle to be removed from the implement handle shaft. In other further embodiments, a surface of the upper clamp housing in contact with the implement handle shaft, a surface of the lower damper bar in contact with the implement handle shaft, or both surfaces, further comprise nubby grippers. In yet other further embodiments, the lower damper bar comprises means by which the damper bar can be pivoted around one bolt while a second bolt remains in place, allowing the auxiliary handle to be removed from the implement handle shaft, and a surface of the upper clamp housing in contact with the implement handle shaft, a surface of the lower damper bar in contact with the implement handle shaft, or both surfaces, further comprise nubby grippers.

In other further embodiments, means to detachably attach any auxiliary handle as described above to the implement handle shaft comprise a belt, where the belt passes below an implement handle shaft, means to attach the belt to the auxiliary handle, and means to tighten the belt.

The foregoing and other objects, characteristics and advantages of the present invention will be more clearly understood from the following detailed description thereof when read in conjunction with the accompanying drawings.

### DESCRIPTION OF THE FIGURES

FIG. 1 shows a perspective view of one embodiment of a detachable auxiliary handle for a long-handled manual material moving implement independent of its attachment to any particular implement.

FIG. 2 shows a side view of the embodiment of a detachable auxiliary handle for a long-handled manual material moving implement shown in FIG. 1.

FIG. 3 shows a perspective view of the embodiment of a detachable auxiliary handle for a long-handled manual material moving implement shown in FIG. 1, where the auxiliary handle is fastened to the handle shaft of a shovel.

FIG. 4 shows a perspective view of a detachable auxiliary handle fastened to the handle shaft of a shovel and illustrates the range of mounting possibilities of the auxiliary handle both along and around the handle shaft.

FIG. 5 shows a perspective view of another embodiment of a detachable auxiliary handle for a long-handled manual material moving implement independent of its attachment to any particular implement.

FIG. 6 shows a side view of the embodiment of a detachable auxiliary handle for a long-handled manual material moving implement shown in FIG. 5. FIGS. 6A and 6B show two different ways in which a hand grip may be attached to the handle member.

FIG. 7 shows a perspective view of the embodiment of a detachable auxiliary handle for a long-handled manual material moving implement shown in FIG. 5, where the auxiliary handle is fastened to the handle shaft of a shovel.

FIG. 8 shows three views of a damper bar; panel 8A shows a side view of a first side, panel 8B shows a side view of a second side, and panel 8C shows a top view.

FIG. 9 shows two views of a first embodiment of a clamp; FIG. 9A shows a side view, and FIG. 9B shows an end view.

FIG. 10 shows two views of a second embodiment of a clamp; FIG. 10A shows a side view, and FIG. 10B shows an end view.

FIG. 11 shows two views of a third embodiment of a clamp; FIG. 11A shows a side view, and FIG. 11B shows an end view.

FIG. 12 shows an end view of a clamp, with nubby grippers shown in detail.

FIG. 13 shows a perspective view of one embodiment of a detachable auxiliary handle for a long-handled manual material moving implement independent of its attachment to any particular implement; in this embodiment, the means for attaching the auxiliary handle to an implement handle is a belt.

FIG. 14 shows a perspective view of the embodiment of a detachable auxiliary handle for a long-handled manual material moving implement shown in FIG. 13, where the auxiliary handle is fastened to the handle shaft of a shovel

FIG. 15 shows a perspective view of a detachable auxiliary handle fastened to the handle shaft of a shovel as shown in FIG. 14, and illustrates the range of mounting possibilities of the auxiliary handle both along and around the handle shaft.

FIG. 16 shows side views of different embodiments of an arched frame of a detachable auxiliary handle. Panel A shows an arched frame with a cross piece and a lateral sleeve on the forward leg; Panel B show an arched frame with a cross piece and a lateral sleeve on the cross piece; and Panel C shows an arched frame with a junction box with an integral lateral sleeve.

FIG. 17 shows two different perspective views of a belt assembly block with a hook-type fitting on one end (panel A), and a ratchet fitting on the opposite end (panels B). Two different ratchet fittings are shown in panels B and C.

FIG. 18 shows side views an angled frame of a detachable auxiliary handle. Panel A shows the frame with a slot on the forward leg to accommodate a belt assembly block. Panel B shows the frame with the belt assembly block in the frame, with the hook-type fitting showing, and Panel C shows the frame with the belt assembly block in the frame with the ratchet fitting showing; in these views, the belt is not shown.

FIG. 19 shows two opposite side views of a detachable auxiliary handle with an angled frame, with a slot for accommodating a belt assembly block and a complete belt assembly block in the slot. Panel A shows the handle with the hook type fitting showing, and Panel B shows the handle with the ratchet fitting showing; in these views, the belt is shown.

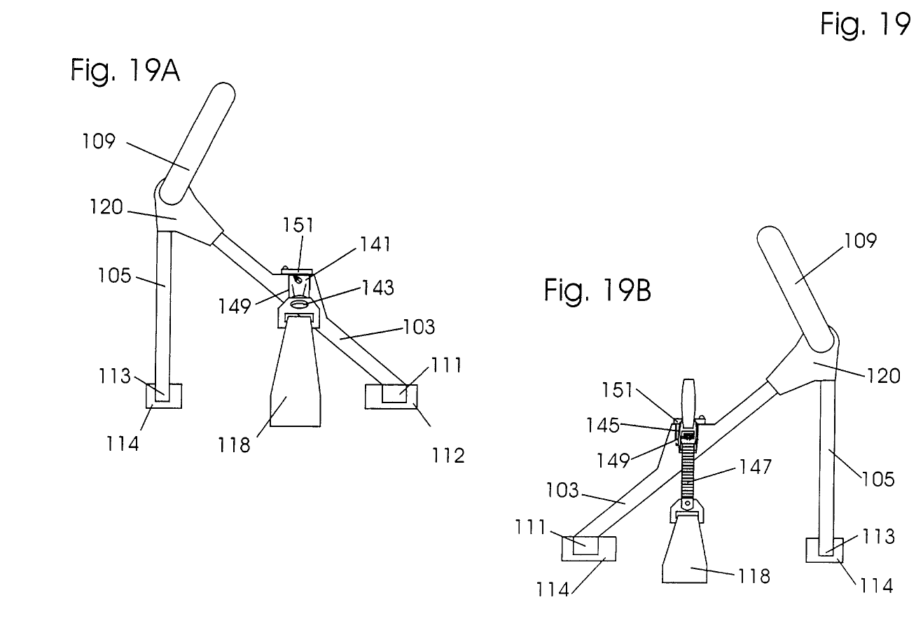

FIG. 20 shows side views of an arched frame of a detachable auxiliary handle with a lateral sleeve on the forward leg; panel A shows a two-legged frame in which the forward leg is arched, and panel B shows a single-legged frame. Panels C, D, and E show perspective views of a belt assembly block, where panel C shows the block with the ratchet fitting showing, and panels D and E show the block with the hook-type fitting showing. Panel E demonstrates that a hook-type fitting that can swing to the side to allow removal of the block from the opening in the lateral sleeve

FIG. 21 shows a side view of an angled frame of a detachable auxiliary handle with a cross piece to which is attached a ratchet mechanism with a slide with hooks to which a belt can be detachably attached (panel A). Panel shows a front view of the ratchet mechanism with the range of motion of the slide shown by the arrow. Panel C shows a front view of the ratchet mechanism with a belt detachably attached at one end to one of the hooks on the side of the bottom of the slide, passing under an implement handle shaft (shown in cross-section) and ready for attachment to the other hook on the other side of the slide.

### DESCRIPTION OF THE INVENTION

The present invention relates to auxiliary handles for long-handled implements used to manually move or manipulate materials, such as shovels and pitchforks, and in particular to an improved detachable auxiliary handle which enables use of an implement without twisting and thus decreases back strain and back injury. The present invention also provides increased leverage and control; this is of particular utility for very-long handled tools, such as snow rakes and tools used for grooming the surface of wet concrete.

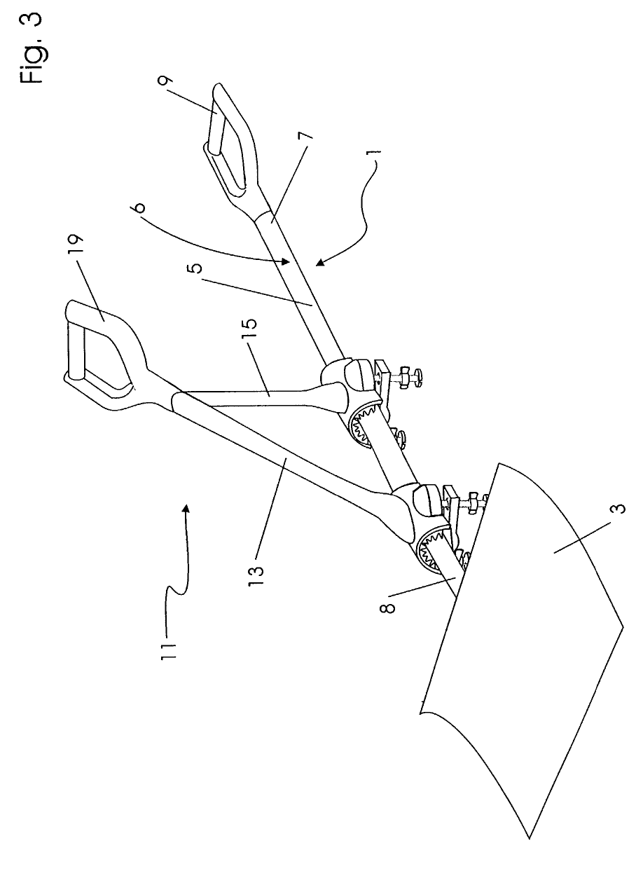

The present invention provides a detachable auxiliary handle for a long-handled manual material-moving implement. Conventional manual material-moving implements, such as a shovel 1 as is shown in FIG. 3 or a fork, typically comprise a material-engaging scoop 3 or fork with a long handle shaft 5 rigidly affixed to it at one end 8 of the shaft, while the other end of the handle shaft, the free end or user end 7, serves as a handle, and frequently comprises a hand grip 9. The upper surface 6 of the handle shaft 5 is that surface which faces generally in the same direction as the material engaging portion of the implement, such as the scoop 3 of a shovel 1; the lower surface 5 of the handle shaft 5 is that surface which faces generally in the opposite direction as the material engaging portion of the implement.

The following paragraphs describes general aspects of an auxiliary handle of the present invention; these aspects include frame configuration, means of attaching an auxiliary handle to an implement handle shaft, handle ends and hand grips when present, and contacts with an implement handle shaft. Different embodiments comprise various combinations these aspects.

Frame Configuration

In one aspect, the present invention provides an auxiliary handle which comprises an angled frame, where the frame comprises two members, or legs, of which the first leg is nearer to the user when the auxiliary handle is attached to the implement (also referred to as a rear leg), and of which the second leg is nearer to the material moving end of the implement when the auxiliary handle is attached to the implement (also referred to as a forward leg). The two legs of the frame intersect to form an angle; typically, the angle is about 45 degrees, although other angles are contemplated. A first end of each leg is in contact with the implement handle, whereas the second end of one leg is attached to the other leg at a distance slightly below the second end of the other leg to form the angle, such that the second end of the other leg extends beyond the angle to form a free end or handle end. Thus, depending upon the configuration, the second end of either leg may form a free end or handle end. The auxiliary handle further comprises means to detachably attach the auxiliary handle to the implement handle shaft. In this aspect, when attached to the implement handle, the first leg is typically about perpendicular to the implement handle, although other angles are contemplated.

In another aspect, the present invention provides an auxiliary handle which comprises an angled frame, where the frame comprises two members, or legs, of which the first leg is nearer to the user when the auxiliary handle is attached to the implement (also referred to as a rear leg), and of which the second leg is nearer to the material moving end of the implement when the auxiliary handle is attached to the implement (also referred to as a forward leg). The two legs of the frame intersect to form an angle; typically, the angle is about 45 degrees, although other angles are contemplated. A first end of each leg is in contact with the implement handle, and the second end of one leg is attached to the second end of the other to form the angle at the intersection of the two legs. In this aspect, neither second end of either leg extends beyond the angle to form a free end, and a hand grip is attached to the auxiliary handle at the intersection of the two legs. The auxiliary handle further comprises means to detachably attach the auxiliary handle to the implement handle shaft. In this aspect, when attached to the implement handle, the first leg is typically about perpendicular to the implement handle, although other angles are contemplated.

In yet another aspect, the present invention provides an auxiliary handle which comprises an arched or curved frame, where the frame comprises a single member, or leg, of which a first end is nearer to the user when the auxiliary handle is attached to the implement (also referred to as a rear end; the region of the frame is a rear region), and of which a second end is nearer to the material moving end of the implement when the auxiliary handle is attached to the implement (also referred to as a forward end; the region of the frame is the forward region). In this aspect of the present invention, the first end and the second end of the leg are in contact with the implement handle shaft. In preferred embodiments, the arch is not symmetrical, such that the curve of the single member from the second end or of the forward region increases to a high point or region, from which it then rapidly curves downward such that the portion from the high point to the first end (or the rear region) is typically about perpendicular to the implement handle shaft, although other angles are contemplated. Thus, the length of the frame from the second end to the high point or region (or the length of the forward region) is greater than the length of the frame from the high point to the first end (or the length of the rear region). In further preferred embodiments, the arch is concave with respect to the implement handle shaft. In other embodiments, the arched frame comprises two legs, where the legs are attached or connected at a high point; in these embodiments, a first end of each leg is in contact with the implement handle, and the second end of one leg is attached to the second end of the other to form an intersection of the two legs. In some embodiments, the two legs are joined to form a continuous arch; in other embodiments, the two legs are joined at an angle, where the angle ranges from about 45 degrees to about 180 degrees. In different embodiments, both or only one leg is curved to form an arched frame; if both legs are curved, the degree of curvature need not be the same in both legs. In particular embodiments, the leg nearer to the user when the auxiliary handle is attached to the implement (also referred to as a rear leg) is typically nearly straight or only slightly curved, and the leg nearer to the material moving end of the implement when the auxiliary handle is attached to the implement (also referred to as a forward leg) is curved or curved to a greater degree than the rear leg; in some embodiments, the rear leg is typically about perpendicular to the auxiliary handle, although other angles are contemplated. In some embodiments, the legs are joined in a junction box, as described below. In this aspect of the present invention, a hand grip is attached to the auxiliary handle, at the high point of the arch; in some embodiments, the hand grip is attached to the junction box with connects two legs of the auxiliary handle frame together. The auxiliary handle further comprises means to detachably attach the auxiliary handle to the implement handle shaft.

In any aspects of the auxiliary frames described above, the legs of the frame may be integrally fabricated, or they may be separately fabricated and attached by means well known in the art. The intersection of the legs, or the high point of a single leg of an arched frame, may be further strengthened; such strengthening imparts greater resistance to bowing under pressure, as for example, under tightening of a belt attachment of an auxiliary handle to an implement handle shaft, or under a load when the implement is in use. Such strengthening may impart greater rigidity, and may be accomplished, for example, by the presence of additional material at the intersection, or by thickening the legs at the intersection or by both. Other means of strengthening the intersection or high point, and of attaching two legs, comprises a junction box, which is appropriately configured to receive the second end of either leg, such that the second end of one leg extends through the junction box to form a handle end, and the second end of the other leg is retained within the junction box, or such that neither second end of either leg extends through and both second ends are retained within the junction box. In some embodiments in which neither second end of either leg forms a free or handle end and a junction box is present, a hand grip is attached to the junction box. The hand grip may be integrally formed with the junction box, or separately fabricated and attached to the junction box.

In any of the aspects described above, a frame of an auxiliary handle may further comprise a cross piece, which is a third member or leg connecting a first leg with a second leg below the intersection of the two legs of an angled frame and above the ends of the legs in contact with an implement handle shaft, essentially forming a triangular frame, or connecting the first arched section or leg with a second arched section or leg in an arched frame below the high region and above the ends of the legs in contact with an implement handle shaft. The cross piece may be straight or curved; when curved, the curve is generally convex with respect to an implement handle shaft when the auxiliary handle is in use. When an auxiliary handle is attached to an implement handle shaft, a straight cross piece is generally about parallel to an implement handle, though other angles are contemplated.

It is contemplated that different frame configurations of an auxiliary handle provide different advantages for different situations. While it is not necessary to understand the mechanism to practice the invention, and the invention is not intended to be limited to any particular mechanism, it is believed that an auxiliary handle comprising an angled frame may use less material, as measured lineally, and thus may be lighter weight. It is further believed that an angled frame may be more compact, which may be significant when the user is trying to insert the mechanism attached to a long-handled tool into tight spaces. On the other hand, it is believed that an auxiliary handle comprising an asymmetrically arched frame may be lighter (and accordingly more flexible) in a static condition than an angled frame. This is because the single-piece body's unsymmetrical arch design assumes considerable rigidity when used when a belt and when the belt is tightened against an implement handle shaft. It is further believed that the bottom portions of the arched frame may be more flexible than the top of the arch, which is believed to require a higher degree of rigidity to accommodate a load. It is further believed that a cross piece adds rigidity to an arched frame.

Attachment to Implement Handle

In all the aspects of the present invention described above, the auxiliary handle further comprises means to detachably attach the auxiliary handle to the implement handle shaft.

In some embodiments, the attachment means are clamps; in particular embodiments, the clamps are formed at or attached to the ends of the legs of an auxiliary handle frame which are in contact with the implement handle shaft, and provide sufficient pressure to attach the auxiliary handle to the implement handle shaft such that it does not rotate around and does not slide along the implement handle shaft when in use. Clamps are well known in the art, and include muffler clamp type arrangements and cam clamps.

In other embodiments, the attachment means comprises a belt, where the belt slides under the implement handle shaft and is attached to the frame of an auxiliary handle, and means to attach the belt to the auxiliary handle, and means to tighten the belt, wherein the belt can be tightened to provide sufficient pressure to attach the auxiliary handle to the implement handle shaft such that it does not rotate around and does not slide along the implement handle shaft when in use. Many different means of attaching a belt to the frame of an auxiliary handle and of tightening the belt are contemplated. In some embodiments, attachment means are located on a forward leg or portion of a frame; in other embodiments, attachment means are located on a cross piece when present. Attachment means include but are not limited to a raised ledge on the forward leg of a frame or a groove or channel in the forward leg of a frame into which the belt fits, where the ledge or groove or channel prevents the belt from sliding down the frame; the belt may be placed behind the ledge, or into the groove or channel, from which it can be easily removed, or the belt may be further attached by means including but not limited to a bolt, a screw, a staple, or glue to the frame. Tightening means may be present on the belt alone. Other tightening means are attached to the frame and to the belt. Thus, in some embodiments, a belt is fixedly or detachedly attached to an auxiliary handle at one of the belt, as by a hook or by a screw, and further attached to the auxiliary handle at the other end of the belt by a tightening means, such as a ratchet, which is fixedly or detachedly attached to the auxiliary handle. Other non-limiting attachment means include a saddle, which is attached to an auxiliary frame and which includes means for holding a belt or a belt assembly block (described further below). In some embodiments, the saddle wraps around a member of the frame, such as a forward leg or a cross piece when present, and extends below the member to form an extension, where the extension comprises an opening through which a belt or a belt assembly block can be inserted. Yet other non-limiting attachment means include a belt assembly block, which comprises means to attach a belt to the block and which may further include means to tighten the belt; the belt assembly block can then be detachably or fixedly attached to the auxiliary handle frame. A belt may be fixedly attached to a belt assembly block, as with bolts, screws, nails, staples, or glue, or it may be removably attached to a belt assembly block, as by a hook.

A belt assembly block is generally an elongated block comprising two ends, and may be rectangular or ovoid or other shape in circumference, with belt attachment means at either or both ends. A belt assembly block is attached to an auxiliary handle on the forward leg, or on a cross piece when present, such that the belt is able to pass underneath an implement handle shaft when in use. In particular embodiments, an auxiliary handle frame is configured to received a belt assembly block, such as by comprising a ledge or groove or channel, into which the belt assembly block can be placed. The belt assembly channel may be fixedly attached to the auxiliary handle, or preferably may be detachably attached to the auxiliary handle; when a belt assembly handle is detachably attached, additional means to lock the belt assembly block in place may be present. Such locking means include but are not limited to an arm which swings into place over the belt assembly block.

Means to tighten the belt may also be means to attach the belt to the block. In some embodiments, tightening means include a ratchet mechanism into which the belt is threaded, where various ratchet mechanisms are contemplated. **In some embodiments, tightening means are attached to an auxiliary handle frame or to a belt assembly block which can be attached to an auxiliary handle frame; a belt is then attached to the tightening means at both ends of the belt, where at least one end of the belt is detachably attached to the tightening means. In particular embodiments, tightening means attached to an auxiliary handle frame or to a belt assembly block comprise a jack-like assembly, by which the ends of the belt attached to the tightening means are jacked up toward the auxiliary handle, thus tightening the belt and securely attaching the auxiliary handle to the implement handle.

Handle Ends and Hand Grips

As described above, in some embodiments of an angled frame auxiliary handle, a second end of either leg may extend beyond the angle of intersection to form a free end or handle end; in particular embodiments, the free end is fashioned into a hand grip, and in other particular embodiments, a hand grip is attached to the free end. In other embodiments, neither second end of either leg extends beyond the intersection of the two legs, and a hand grip is attached to the frame at the angle of intersection. In yet other embodiments, a hand grip is attached to an arched frame at the highest point. As described above, in some embodiments, the frame of an auxiliary handle is strengthened at the intersection or high point by the presence of additional material, or a thicker frame, or by the presence of a junction box, into which the legs of the frame are inserted to form the intersection or the high point; in these embodiments, a hand grip is attached to the strengthened area, or to a junction box.

Hand grips are well known, and any suitable configuration is contemplated. Particular configurations include an opening through which the users' fingers can be curled; the opening may be formed, for example, by a cross bar which is supported by two side bars which join into a single bar which can be configured to attached to the angled frame. Other configurations include an oval grip, which comprises a bar curved or bent into an oval shape which may be slightly flattened on one side which is attached to the auxiliary handle. A hand grip may further comprise a non-slip gripping surface, such as a textured surface or indentations into which a users fingers may be placed; the gripping surface may be made of a comfortable material such as rubber or foam. A hand grip may comprise different surfaces, such as smooth areas on which a users' hand may easily slide, and non-slip gripping surfaces.

A hand grip may be attached to an auxiliary frame by any well known configuration. In auxiliary handles in which neither leg forms a free or handle end, the angle of the grip relative the legs can vary, from approximately parallel to the rear leg to approximately parallel to the forward leg, to approximately perpendicular to the forward leg.

Contact with Implement Handle Shaft

An auxiliary handle shaft contacts an implement handle shaft at the ends of the legs of the frame. In some embodiments, the ends of the legs comprise feet which extend beyond the diameter of the legs to form a surface contoured and configured to fit an implement handle shaft; feet may be circular, flaring around the ends of the legs, or they may be elongated, flaring out from the ends of the legs and along the length of the implement handle shaft, and they may be flared to fit around the diameter of the implement handle shaft (but no more than about half-way around), or any combination of appropriate shape. In these embodiments, the surface of the feet which contact the implement handle shaft may further comprise a texturized treatment, or materials applied to the surface, which increase the grip of the auxiliary handle to the implement handle shaft. Materials which provide surface texture include but are not limited to tackifiers, rubber, and foam. The surface may further comprise a pattern which is deformable. The surface may also comprise nubby grippers, as described further below. In these embodiments in which the auxiliary handle shaft is attached to an implement handle shaft by a belt, the surface of the belt which contacts the implement handle shaft may also further comprise texturized treatment, or materials applied to the surface, which increase the grip of the auxiliary handle to the implement handle shaft, as described above and below.

In other embodiments, an auxiliary handle shaft contacts an implement handle shaft at the ends of the legs of the frame, which leg ends comprise clamps which attach the frame to the implement handle shaft. Exemplary clamps are described further below; moreover, the surfaces of the clamps which contact the implement handle shaft may further comprise any of the texturized treatments or materials which increase the grip of the auxiliary handle to the implement handle shaft as described above and below.

Particular Embodiments

The following paragraphs describes particular embodiments of an auxiliary handle of the present invention; these embodiments comprise various combinations of frame configurations, attachments, hand grips, and contacts with an implement handle shaft. It is understood that other combinations are contemplated.

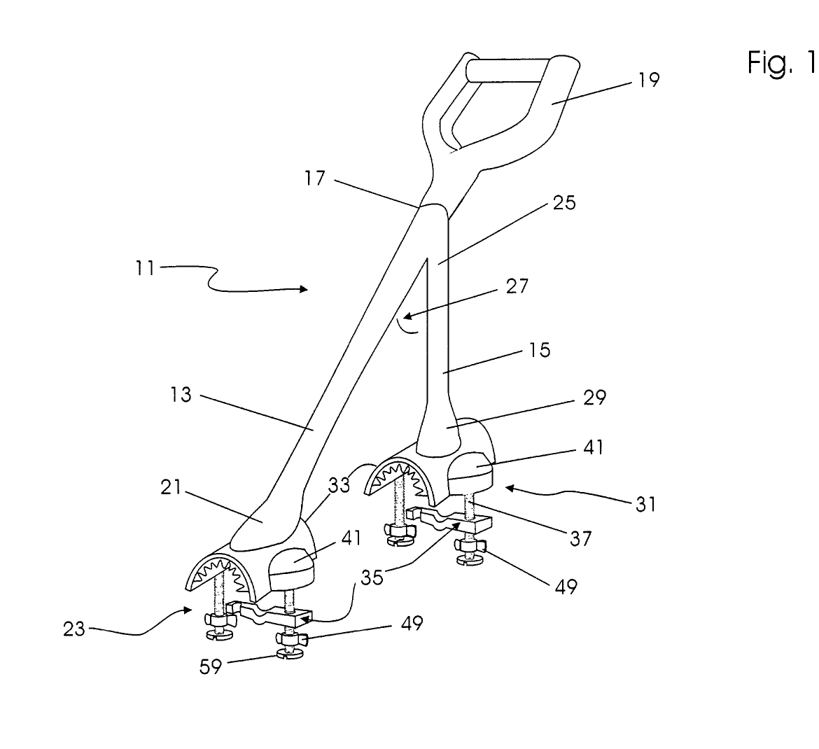

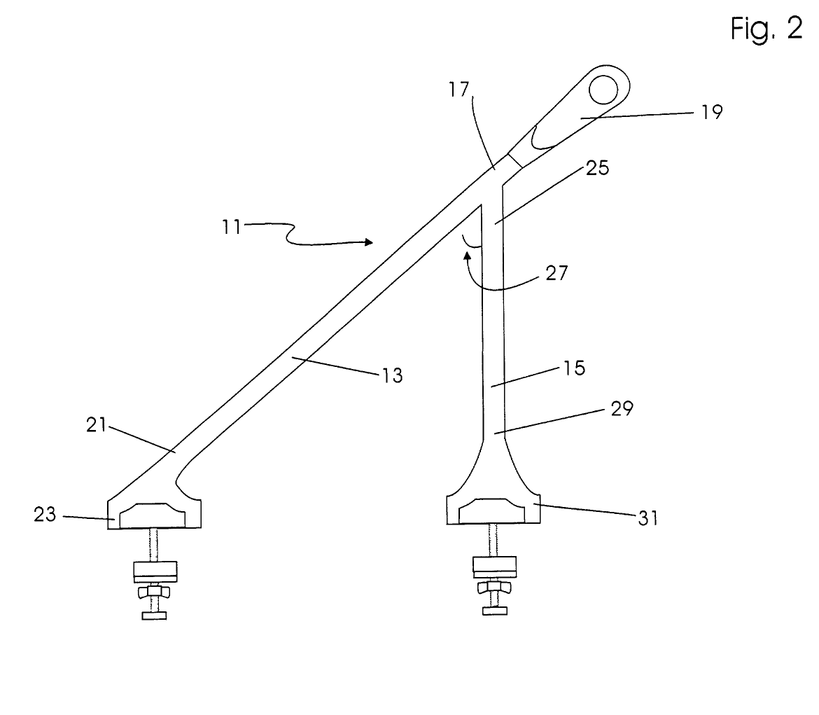

One embodiment of the first aspect of the auxiliary handle 11 of the present invention is shown in FIGS. 1 and 2, and comprises an angled frame, of which the second member or leg is a handle member 13 and of which the first member or leg is a brace member 15. The second end of the handle member 13 is the free end 17, which is grasped by the user's hand, and may further comprise a hand grip 19; the first end 21 of the handle member 13 comprises means for attaching the handle member 13 to the handle shaft 5; preferably, such means is a clamp 23 which is attached to the implement handle shaft 5 nearer the shovel or fork end 8. The second end 25 of the brace member 15 is attached to the handle member 13 near the handle member free end 17, to form an angle 27 with the handle member 15; the first end 29 of the brace member 15 comprises means for attaching the brace member 15 to the handle shaft 5; preferably, such means is a clamp 31 that is attached to the implement handle shaft 5 nearer the free end 7. The auxiliary handle 11 of the present invention attaches to a long handle shaft 5 of an implement such as a shovel 1 as shown in FIG. 3.

The free end 17 of the handle member 13 extends beyond the point at which the brace member 15 is attached to it, and toward the user when in use. The free end 17 may simply comprise the end of the handle member 13; in this case, the free end 17 is preferably rounded, and may be further shaped to provide a secure gripping surface. Alternatively, the free end 17 may further comprise a hand grip 19, where the hand grip 19 provides means by which a user's hand may grip the auxiliary handle 11 at right angles to the handle member 13; an example of a hand grip 19 is shown in FIG. 1. The hand grip 19 may be formed integrally to the handle member 13, or it may be separately formed and attached to the handle member 13; preferably, it is fixedly attached, such as by a threaded connection, by glue or welding, or by fasteners such as bolts, nails, screws, staples or pins. The free end 17 or the hand grip 19 may further comprise a texturized gripping surface; the gripping surface may be made of a comfortable material such as rubber or foam.

The handle member 13 and brace member 15 are preferably tubular in shape, of a diameter similar to those found in the handle shafts 5 of the implements to which the auxiliary handle 11 may be attached. The brace member 15 is fixedly attached to the handle member 13 at an appropriate angle 27 such that the brace member 15 is about perpendicular to the handle shaft 5 of the implement and the handle member 13 is about at a 45 degree to the handle shaft 5 when the auxiliary handle 11 is attached to the handle shaft 5 of an implement, although other angles are contemplated. The handle member 13 and brace member 15 may be connected integrally, or they may be separately formed and attached securely together, such as by a threaded connection or by welding or glue.

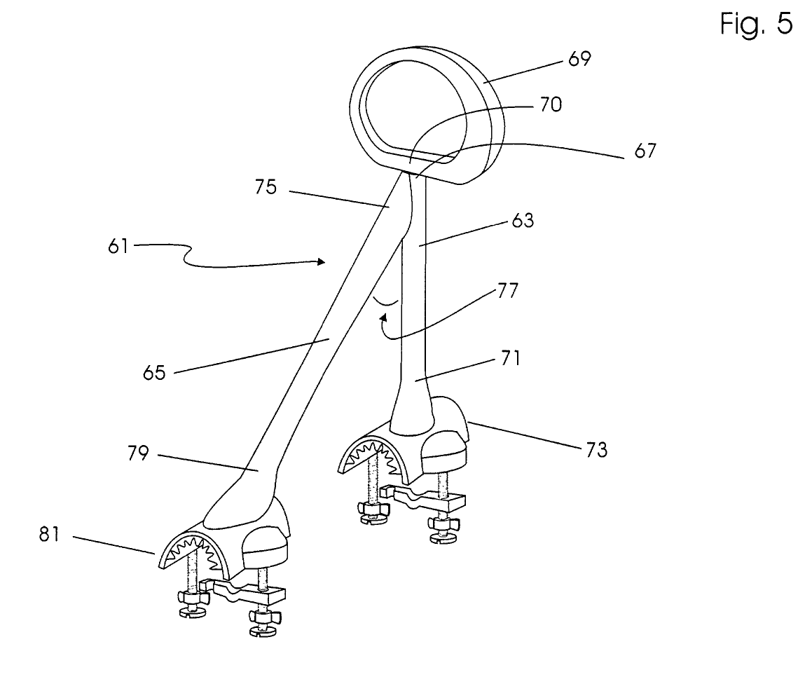

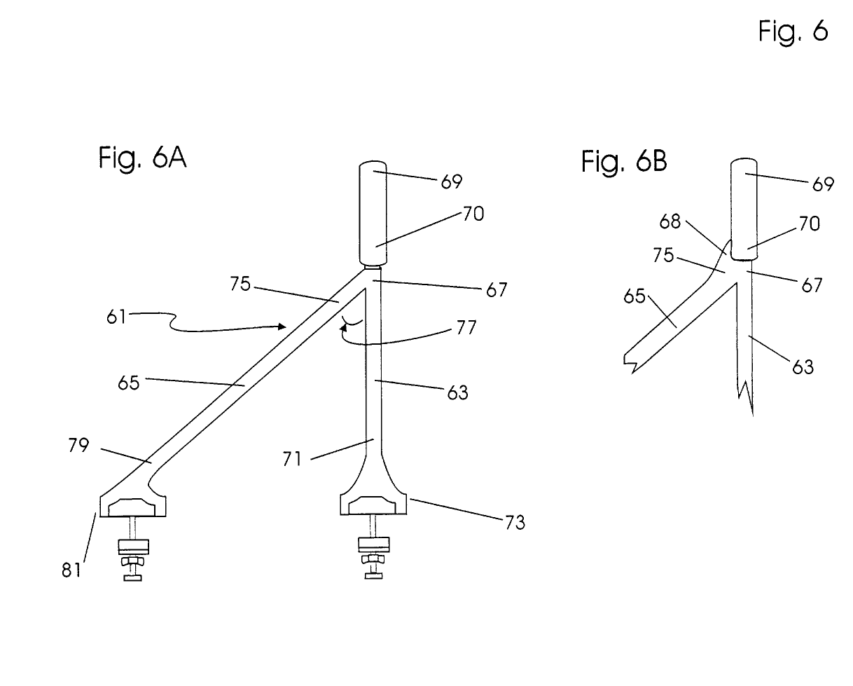

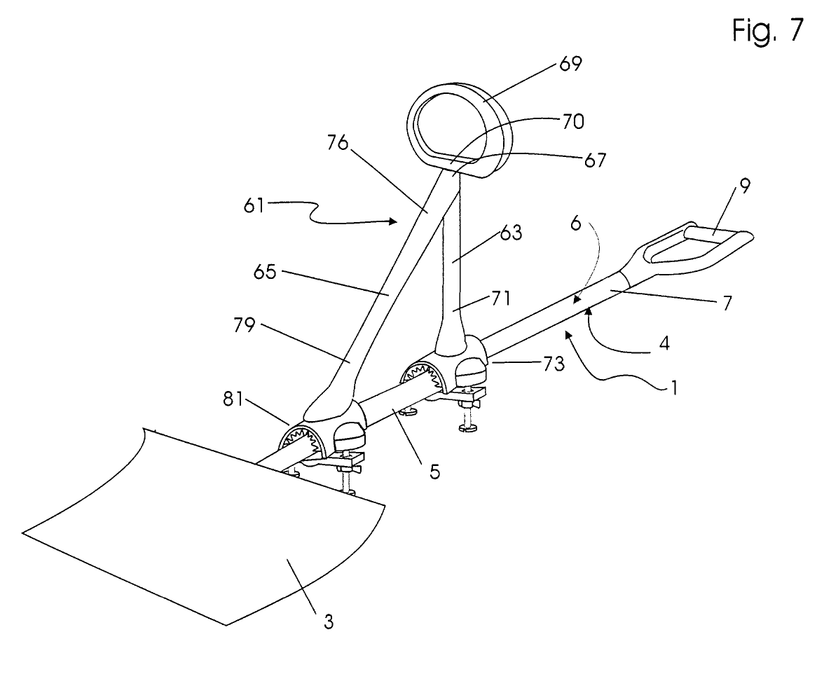

Another embodiment of the auxiliary handle 61 of the present invention is shown in FIGS. 5 and 6, and comprises an angled frame, of which the first member or leg is a handle member 63 and of which the second member or leg is a brace member 65. The second end of the handle member 63 is the free end 67, which is grasped by the user's hand, and may further comprise a hand grip 69. The first end 71 of the handle member 63 comprises means for attaching the handle member 63 to the handle shaft 5; preferably, such means is a clamp 73 which is attached to the implement handle shaft 5 nearer the free end 7. The second end 75 of the brace member 65 is attached to the handle member 63 near the handle member free end 67, to form an angle 77 with the handle member 65. The first end 79 of the brace member 65 comprises means for attaching the brace member 65 to the handle shaft 5; preferably, such means is a clamp 81 that is attached to the implement handle shaft 5 nearer the shovel or fork end 8. The auxiliary handle 61 of the present invention attaches to a long handle shaft 5 of an implement such as a shovel 1 as shown in FIG. 7.

The free end 67 of the handle member 63 extends beyond the point at which the brace member 65 is attached to it, and approximately perpendicular to the handle shaft 5 when in use. The free end 67 may simply comprise the end of the handle member 63; in this case, the free end 67 is preferably rounded, and may be further shaped to provide a secure gripping surface. Alternatively, the free end 67 may further comprise a hand grip 69, where the hand grip 69 provides means by which a user's hand may grip the auxiliary handle 61 at right angles to the handle member 63; an example of a hand grip 69 is shown in FIG. 5. The hand grip 69 may be formed integrally to the handle member 63, or it may be separately formed and attached to the handle member 63; preferably, it is fixedly attached, such as by a threaded connection, by glue or welding, or by fasteners such as bolts, nails, screws, staples or pins. The free end 67 or the hand grip 69 may further comprise a texturized gripping surface; the gripping surface may be made of a comfortable material such as rubber or foam.

A hand grip 69 may be attached to the free end 67 of the handle member 63 in a number of different configurations, two of which are shown in FIG. 6. In one embodiment shown in FIG. 6B, the hand grip 69 is set into the point of attachment of the brace member 65 to the handle member 63. In this embodiment, the top of the second end 75 of the brace member 65 is flared upward 68 above the surface of the handle member 63 to encompass the base 70 of the hand grip 69. This results in increased strength at the attachment of the hand grip 69 to the handle member 63, and tends to counter the tendency of the base 70 of the hand grip 69 to move forward, or toward the material moving end of the long handled implement during use of the auxiliary handle. The presence of the flare 68 may reduce the amount of material needed to secure the hand grip 69 to the handle member 63 when compared to other configurations for attaching the hand grip 69 to the handle member 63. For example, on one configuration, the base 70 of the hand grip 69 must be of sufficient length when attached to the handle member 63 to provide enough strength to counter the tendency of the base 70 to move forward during use of the auxiliary handle 61 during use of the auxiliary handle; this configuration may thus requires more material in manufacturing the additional length of the bas 70 of the hand grip 69.

The handle member 63 and brace member 65 are preferably tubular in shape, of a diameter similar to those found in the handle shafts 5 of the implements to which the auxiliary handle 61 may be attached. The brace member 65 is fixedly attached to the handle member 63 at an appropriate angle 77 such that the handle member 63 is about perpendicular to the handle shaft 5 of the implement and the brace member 65 is about at a 45 degree to the handle shaft 5 when the auxiliary handle 61 is attached to the handle shaft 5 of an implement, although other angles are contemplated. The handle member 63 and brace member 65 may be connected integrally, or they may be separately formed and attached securely together, such as by a threaded connection or by welding or glue.

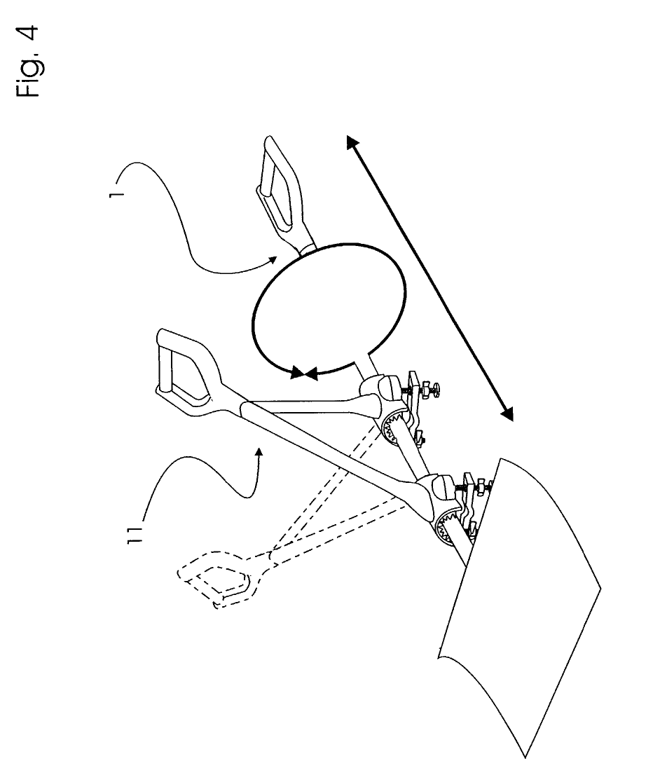

An auxiliary handle of the present invention, such as 11 and 61, is attached to the implement handle shaft 5, in particular embodiments by means of two clamps, one at the first end of the handle member 23,73 and the other at the first end of the brace member 31,81. A number of different clamping means are contemplated. Preferably, the clamps comprise few to no parts which are completely detachable, thereby decreasing the risk that such parts may become lost. Preferably, the clamping means also result in a very strong attachment of the auxiliary handle 11,61 to the implement handle shaft 5, thereby allowing the implement to be used effectively for digging into hard material, such as icy snow, the ground, or compacted hay. Preferably, the clamping means also can be opened sufficiently wide to be attached around the outer diameter of an implement handle shaft 5, without the necessity of sliding the auxiliary handle clamps on and off along the implement handle shaft 5. Preferably, the clamping means can also be loosened sufficiently to allow the auxiliary handle 11,61 to slide around and along the implement handle shaft 5, as shown in FIG. 4. Sliding along the implement handle shaft 5 allows the position of the auxiliary handle 11,61 to be adjusted along the implement handle shaft 5, thus achieving, for example, the greatest comfort and efficiency for any particular user. Sliding or rotating around the implement handle shaft 5 also allows the auxiliary handle 11,61 to be moved into a plane parallel to the shovel blade or fork tines for greater compactness during transportation or storage.

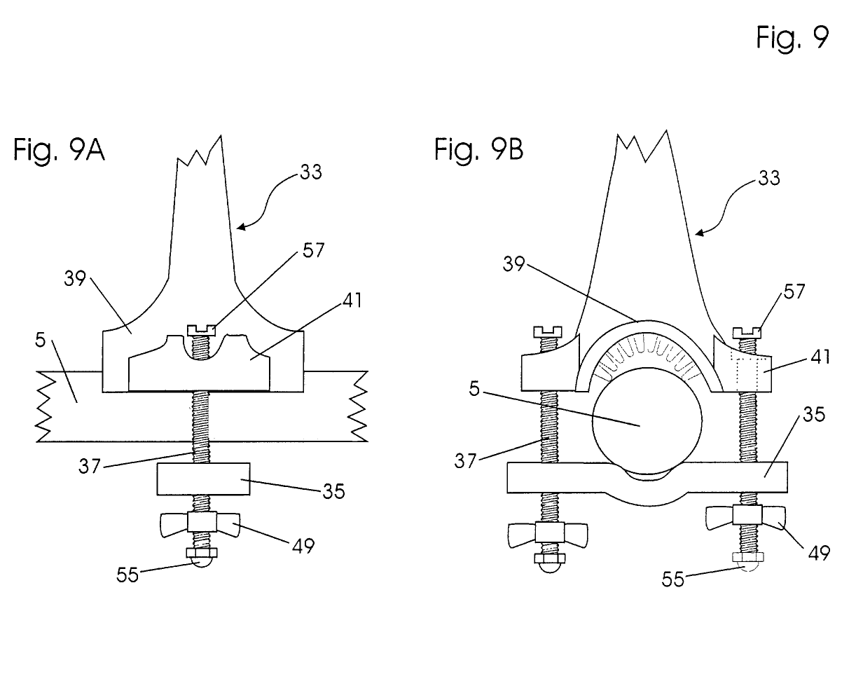

The clamps 23,31,73,81 generally comprise two main components, an upper clamp housing 33 and a lower damper bar 35, as is shown in FIG. 9. These two main components of the clamps 23,31,73,81 are typically joined by bolts 37, although other fastening means are contemplated. The upper clamp housing 33 is shaped to as so accept a leg 13,15,63, 65 of the auxiliary handle 11, 61 and to form a slightly elongated footing 39 at the base or first ends 21,25,71,75 of the auxiliary handle legs 13,15,63,65, where the footing 39 rests on the upper surface 6 of the implement handle shaft 5. The footing 39 is curved in its transverse direction to accommodate the generally circular implement handle shaft 5; thus, the footing 39 of the upper clamp housing 33 may form a semi-circle or ovoid in its cross section, as is shown in FIG. 9. In one embodiment, the upper clamp housing 33 may comprise a curved footing 39 with a hole about in the middle of the footing 39 into which the first end or base of an auxiliary handle leg member 13,15,63,65 may be inserted. In an alternative embodiment, the upper clamp housing 33 may comprise a curved footing 39 to which is attached at an appropriate angle a short tube; a leg member 13,15,63,65 of the auxiliary handle 11 61 may be inserted into the tube, or the tube may be inserted into the leg member 13,15,63,65. In another embodiment, the upper clamp housing 33 may comprise a curved footing 39 which may be bolted or screwed onto the first end or base of an auxiliary handle leg member 13,15,63,65. If bolts 37 are used to fasten the two main clamp components together, the upper clamp housing 33 also comprises at least one bolt holder 41, into which a bolt 37 can be threaded or inserted or embedded; preferably, the upper clamp housing 33 comprises two bolt holders 41, positioned such that one bolt holder 41 is on each side of the implement handle shaft 5. A bolt holder 41 is typically an extension of the curved footing 39 in a direction transverse to the length of the implement handle shaft 5 and extends sufficiently beyond the implement handle shaft 5 such that a bolt 37 placed into the bolt holder 41 will clear the implement handle shaft 5. A bolt 37 extending from a bolt holder 41 is thus positioned on one side of the implement handle shaft 5, but preferably very close to the handle shaft 5. A bolt holder 41 comprises a hole or shaft 43 into which a bolt 37 may be inserted; if the shaft 43 is smooth, the bolt 37 passes smoothly through the shaft 43, whereas if the shaft 43 is threaded, the bolt 37 is threaded into the threaded shaft 43. The upper clamp housing 33 is preferably formed as an integral part of the first end or base of an auxiliary handle member leg 13,15,63,65. In one embodiment, the upper clamp housing 33 comprises a flared curved footing 39 which is an extension of the first end or base of an auxiliary handle leg member 13,15,63,65. Alternatively, the upper clamp housing 33 may be formed separately and securely attached to the first end or base of an auxiliary handle leg member 13,15,63,65 by any of a number of means, including by a threaded connection, or by welding, gluing, or by fasteners such as nails, screws, staples, or pins.

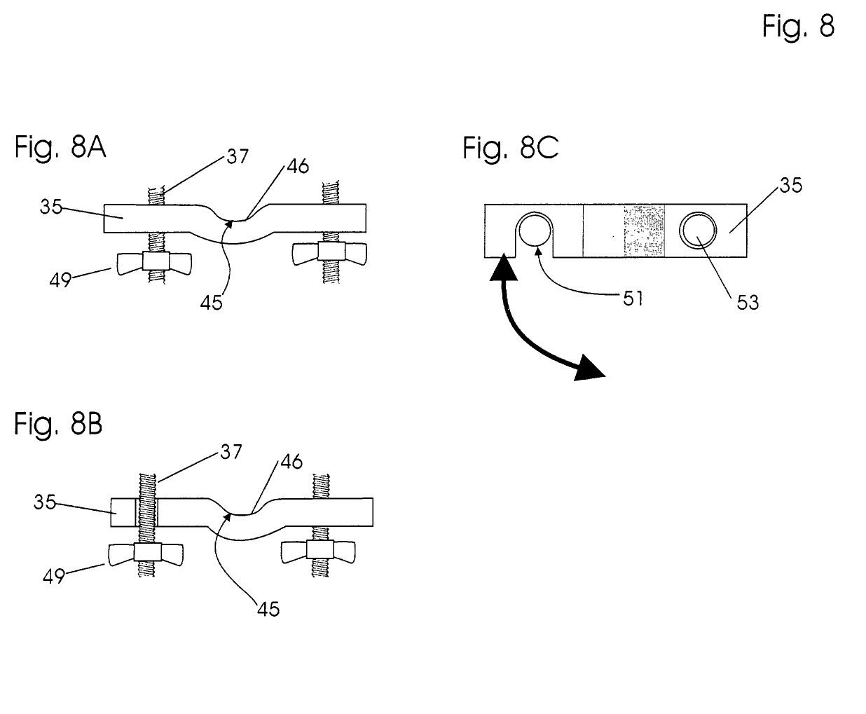

The lower damper bar 35 of the clamp 23,31,73,81 is generally bar or bracket shaped, and is typically configured with a generally curved depression 45 which helps to center the implement handle shaft 5, as is shown in FIG. 8. Preferably, the contours of the curve will not exactly match the contour of the handle shaft 5, but are rounded such that the curve will grip the handle shaft 5 at either one or a few, preferably two, points of contact with the handle shaft. This increases gripping strength, based on the principle that if the compression force created by the tightened clamps is limited to a small area, then the gripping force is a higher number of pounds per square inch. If bolts 37 are used to fasten the two parts of the clamp 23,31, 73, 81 together, the lower damper bar 35 further comprises at least one bolt holder 47, into which a bolt 37 can be threaded or inserted or embedded; preferably, the lower damper bar 35 comprises two bolt holders 47, positioned such that one bolt holder 47 is on each side of the implement handle shaft 5. The bolt holder 47 is typically an extension of the lower damper bar 35 in a direction transverse to the length of the implement handle shaft 5 and extends sufficiently beyond the implement handle shaft 5 such that a bolt 37 placed into the bolt holder 47 will clear the implement handle shaft 5. A bolt 37 extending from a bolt holder 47 is thus positioned on one side of the implement handle shaft 5, but preferably very close to the handle shaft 5. A bolt holder 47 may comprise a threaded insert into which a bolt 37 can be threaded, or a smooth hole or shaft through all or part of a bolt 37 may be inserted. Threading a bolt 37 from the upper clamp housing bolt holder 41 into the lower damper bar bolt holder 47 can clamp the two pieces together. Alternatively, inserting the bolt 37 from the upper clamp housing bolt holder 41 into or through a hole or a shaft in the damper bar bolt holder 47 will typically require a nut 49 which threads onto the bolt 37 below the lower damper bar 35 and acts to clamp the lower damper bar 35 to the upper clamp housing 33. In yet another embodiment, a bolt 37 is inserted into the lower damper bar bolt holder 47 through a hole or shaft and threaded into the upper clamp housing bolt holder 41, thereby clamping the two together.

Several different embodiments of a lower damper bar 35 are contemplated. In one embodiment, the damper bar bolt holders 47 comprise two holes or shafts, through which two bolts 37 from the upper clamp housing bolt holder 41 are inserted. In this embodiment, the auxiliary handle 11,61 is removed from an implement handle shaft 5 by loosening the nuts 49 and moving the damper bar 35 away from the upper clamp housing 33 a sufficient distance to allow the auxiliary handle 11,61 to slide off the free end 7 of the implement handle shaft 5. Alternatively, the nuts 49 are removed and the lower damper bar 35 completely removed from the upper clamp housing 33 to allow that auxiliary handle 11,61 to be lifted away from the implement handle shaft 5. In another embodiment, one of the two damper bar bolt holders 47 comprises a slot 51, which is essentially an extension of one hole or shaft from the center of the hole or shaft to an outer edge of the damper bar, essentially as shown in FIG. 8. The slot 51 is of sufficient diameter and configuration to allow the damper bar 35 to slide past a bolt 37. Thus, when the nuts 49 on the bolt 37 are loosened, the damper bar 35 is able to pivot about a first bolt 37 which extends through the one hole or shaft 53 by sliding off a second bolt 37 which extends through the slot 51, by means of the slot 52. The auxiliary handle 11,61 can then be lifted away from the implement handle shaft 5. This enables the auxiliary handle 11,61 to be unclamped from an implement handle shaft 5 without having to completely remove the damper bar 35, thus making attachment and detachment of the auxiliary handle 11,61 easier and more convenient, and decreasing the likelihood of loss of clamp 23,31,73,81 components.

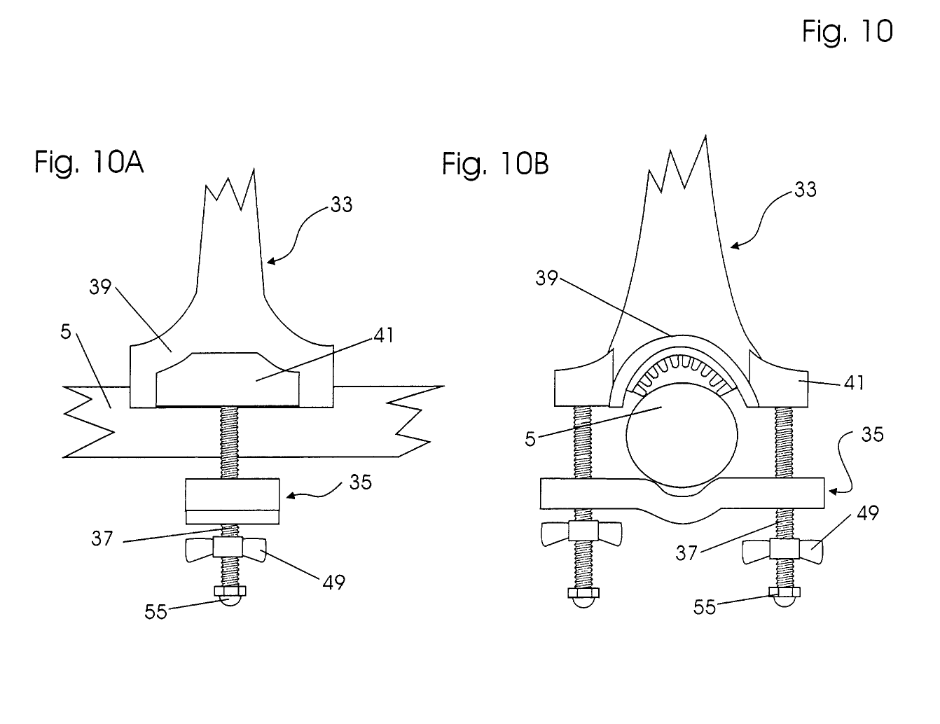

Many different embodiments exist for fastening the two main clamp 23,31,73,81 components together with bolts 37. When nuts 49 are used with the bolts 37, the nuts 49 may be any suitable type, including but not limited to plain nuts, wing nuts, or one and one-quarter wing nuts. In one set of embodiments, two bolts 37 are either inserted or threaded through two bolt holders 41 in the upper clamp housing 33, as shown in FIG. 9. In these embodiments, the bolt holders 41 comprise a shaft extending from the top to the bottom of the extension of the footings 39; the shafts may be smooth or threaded. If the shafts are threaded, they may be threaded during manufacture, such as by molding or machining, or they may contain threaded inserts. The bolts 37 may be inserted by dropping them down through smooth shafts, and the bolts 37 may additionally secured with an adhesive, such as Loc-Tite, or by welding. Alternatively, the bolts 37 may be screwed through threaded shafts. In these embodiments, the damper bar 35 is then fastened to the upper clamp housing 33 by inserting the bolts 47 through bolt holders 47 and tightening the damper bar 35 to the upper clamp housing 33 with nuts 49. The bolts may then be covered with bolt caps 55 (secured with an adhesive, such as Loc-Tite, or by welding) to prevent the nuts 49 from coming off. In another set of embodiments, two bolts 37 are securely fixed to the upper clamp housing 33 by casting them as part of the clamp housing 33, as is shown in FIG. 10. The two clamp components are then fastened as described above.

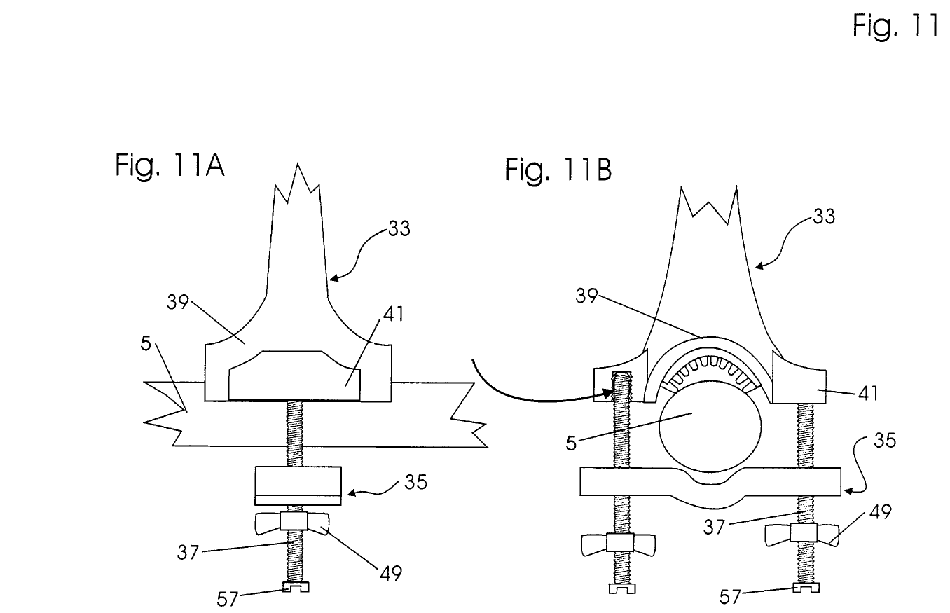

In another set of embodiments to fasten the two main clamp components together, the bolt holders 41 in the upper clamp housing 33 comprise threaded shafts, as is shown in FIG. 11. The shafts may be threaded during fabrication of the clamp component, or they may comprise threaded inserts that accept the appropriate bolt. The damper bar 35 is fastened to the upper clamp housing 35 by inserting bolts 37 through the bolt holders 47 in the damper bar 35 and then screwing them into the threaded shafts in the upper clamp housing 35. The bolt holders 47 in the damper bar 35 may be threaded, or they may be smooth, in which case nuts 49 are used to clamp the two components together. In the latter case, the head 57 of the bolts 37 prevent the nuts 47 from coming off the bolts 37, and no bolt cap 55 is needed.

Other means by which the upper clamp housing is fastened to the lower damper bar are also contemplated. In one embodiment, buckles are used, in which the two pieces of the clamp are snapped together by components which pull the upper clamp housing 33 and the lower damper bar together and then lock; these are similar to the mechanism used for ski boot buckles.

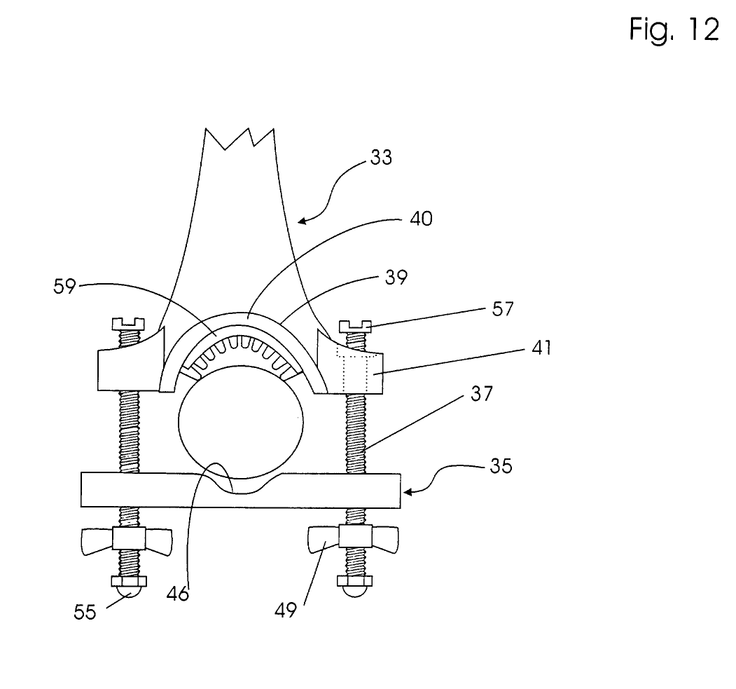

In preferred embodiments, the concave surface 40 of the upper clamp housing and the concave surface 46 of the lower damper bar depression 45 which comes into contact with the implement handle shaft is treated so as to increase the grip of the clamp 23,31,73,81 on the implement handle shaft 5. In some embodiments, the treatment is to texturize the surface 40,46; in other embodiments, materials are applied to the surface 40,46. Materials which provide surface texture include but are not limited to tackifiers, rubber, and foam. The surface may further comprise a pattern which is deformable. In another embodiment, one or both surfaces 40,46 further comprise nubby grippers 59, as shown in FIG. 12; preferably, the upper clamp housing concave surface 40 comprises nubby grippers 59. A nubby gripper is a surface containing a plurality of essentially of small “nubs,” which are small, rounded protrusions used as gripping surfaces. A nub may range in length from about as long as it is wide to very elongated or many times as long as it is wide, where an elongated nub may essentially be a rounded strip and may extend the length or width of the gripping surface. Any nubby gripper may contain from one to several rows of such nubs. Preferably, a nubby gripper is fabricated of a firm yet flexible material, such as a rubber. Nubby grippers 59 need not extend along the entire transverse concave surface 40,46 of the clamp components, as this might unnecessarily limit the diameter of the implement handle shaft 5 that can be accommodated by the clamps 23,31,73,81. Neither do the nubby grippers need to extend along the entire length of the clamp. A basic principle of the nubby grippers 59 is to apply the compression force created by the tightened clamps 23,31,73,81 to a very small surface area, resulting in high pounds per square inch (“p.s.i.”) at this small surface area. The result is highly increased gripping power. It is not contemplated that all, or even most of the nubby grippers 59 will be in contact with the typical implement handle shaft 5, but instead only a few. In the clamp shown in FIG. 12, only two grippers 59 are shown in contact with the implement handle shaft 5.

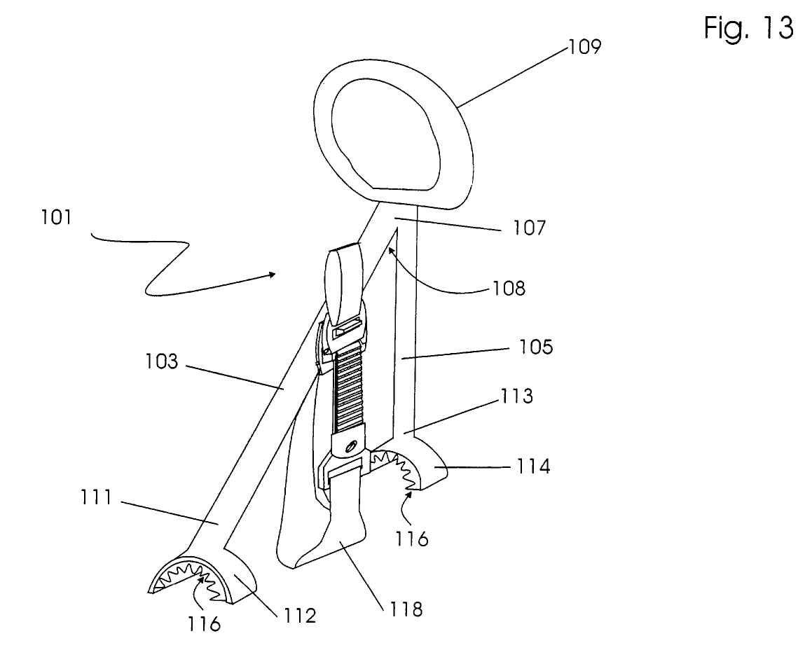

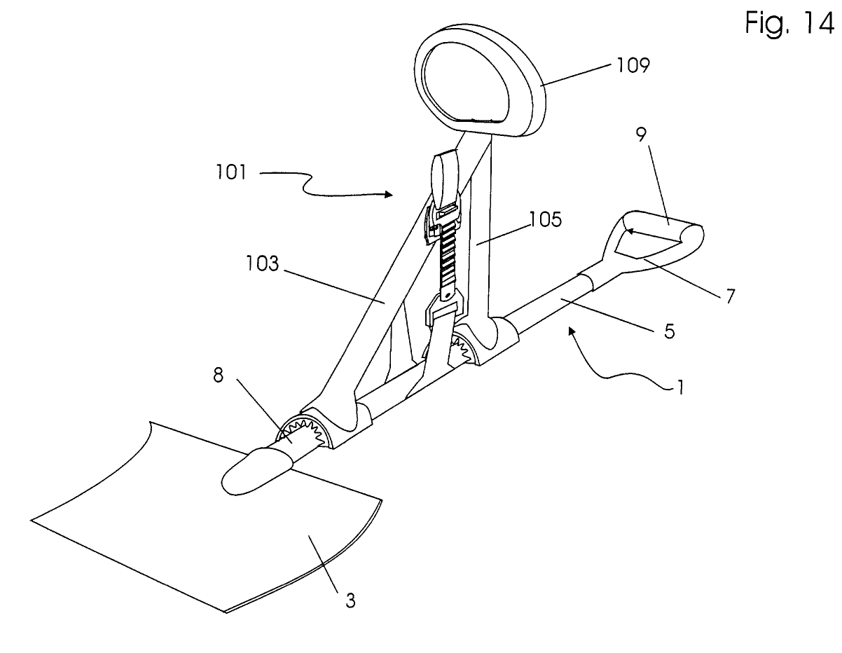

One embodiment of another aspect of the present invention provides an auxiliary handle 101 comprising an angled frame in which neither second end of either leg extends past the second end of the other leg; embodiment of this aspect of the present invention is shown in FIGS. 13, 14 and 15. In this aspect, the angled frame comprises two members or legs, of which the first member or leg is a forward leg 103 and of which the second member or leg is a rear leg 105. In this embodiment, the second end of both the forward leg 103 and the rear leg 105 meet at an intersection 107 to form an angle of about 45 degrees, and neither second end extends beyond the other second end to form a free or handle end. Thus, in this embodiment, a hand grip 109 is attached at the intersection of the forward leg 103 and the rear leg 105. The first end 111 of the forward leg 103 comprises means for contacting the forward leg 103 to the handle shaft 5; in this embodiment, this contact means is a foot 112, which contacts the implement handle shaft 5 nearer the shovel or fork end 8. The first end 113 of the rear leg 105 comprises means for contacting the rear leg 105 to the handle shaft 5; in this embodiment, such means is a foot 114 that contacts the implement handle shaft 5 nearer the free end 7. In this embodiment, the feet 112, 114 are extensions of the second end 111 of the forward leg 103 and of the second end 113 of rear leg 105, where the extensions are curved to fit around the outer diameter of an implement handle shaft 5. Moreover, in this embodiment, the surface of the feet further comprise material 116 to aid in gripping the implement handle shaft 105. The auxiliary handle 101 of the present invention attaches to a long handle shaft 5 of an implement such as a shovel 1 as shown in FIG. 14. When attached to an implement handle shaft 5, the rear leg 105 is about perpendicular to the handle shaft.

In this embodiment, a hand grip 109 is attached to the intersection 107 of the second ends of forward leg 103 and rear leg 105. Although various configurations of the hand grip 109, and various angles of attaching the hand grip 109 to the intersection 107, are contemplated, in the embodiment illustrated in FIG. 13 the hand grip 109 is an open oval in shape, and attached at an angle of about 45 degrees toward the forward leg 103 and relative to the rear leg 105. The hand grip 109 may be formed integrally to the intersection 107, or it may be separately formed and attached to the intersection 107. When separately attached, the hand grip 109 is preferably fixedly attached, such as by a threaded connection, by glue or welding, or by fasteners such as bolts, nails, screws, staples or pins. The hand grip 109 may further comprise a texturized gripping surface; the gripping surface may be made of a comfortable material such as rubber or foam.

While it is not necessary to understand the mechanism in order to practice the invention, and the invention is not intended to be limited to any particular hypothesis, it is believed that angling the hand grip 109 toward the rear would bring the user's hands closer together, thus reducing leverage during use. When the auxiliary handle is attached to a long-handled tool and is in use, the open oval grip 109 is roughly parallel to the ground. When the user needs to throw material to the side, the user slides his or her hand down the near side of the grip. This repositions the arm and hand into a natural position for throwing to the side.

The forward leg 103 and rear leg are preferably tubular in shape, of a diameter similar to those found in the handle shafts 5 of the implements to which the auxiliary handle 101 may be attached. The forward leg 103 is fixedly attached to the rear leg 105 at an appropriate angle 108 such that the rear leg 105 is about perpendicular to the handle shaft 5 of the implement and the forward leg 103 is about at a 45 degree to the handle shaft 5 when the auxiliary handle 101 is attached to the handle shaft 5 of an implement, although other angles are contemplated. The forward leg 103 and rear leg 105 may be connected integrally, or they may be separately formed and attached securely together, such as by a threaded connection or by welding or glue.

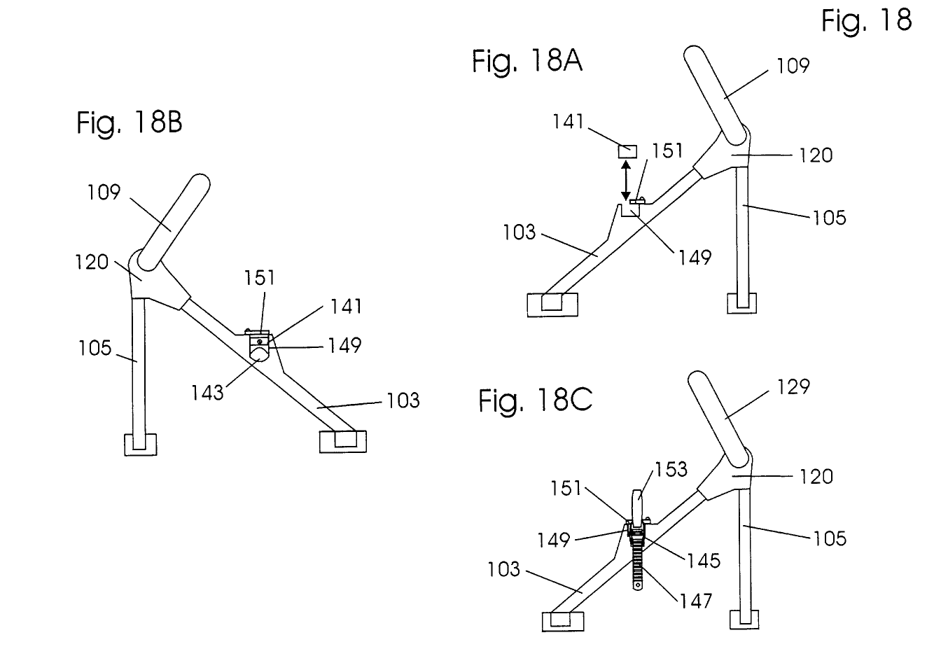

In other embodiments, the forward leg 103 and rear leg 105 are connected via a junction box 120, as shown for example in FIG. 18. Various configurations are contemplated for a junction box 121; in some embodiments, a junction box 121 is additional strengthening material provided at the intersection 107, and in other embodiments, a junction box 120 is a separate component. While it is not necessary to understand the mechanism in order to practice the invention, and the invention is not intended to be limited to any particular hypothesis, it is believed that a junction box 120 provides additional strength to the forward and rear legs 103, 105, and prevents flexing as the lifting up and pushing down forces from the hand grip 109 are redirected and transmitted to the forward and rear legs 103, 105. In the embodiments shown in the Figures, the junction box 120 comprises openings within which the legs 103 and 105 can be inserted and attached, and openings within which a hand grip 109 can be inserted and attached.

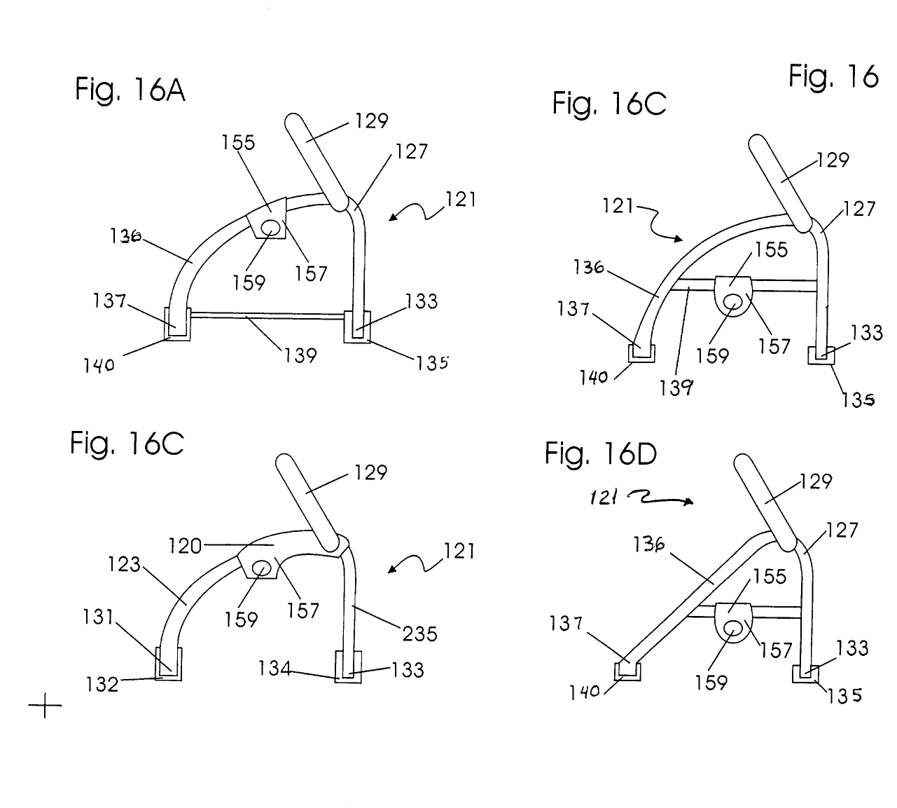

In an embodiment of yet another aspect, the present invention provides an auxiliary handle 121 comprising an arched frame; embodiments of an auxiliary handle 121 of the present invention are shown in FIG. 16. In some of these embodiments, the frame comprises a single member, or leg 136, of which a second end or rear end 138 is nearer to the user when the auxiliary handle 121 is attached to the implement (the region of the frame leg between the rear end 138 and the high point 127 is a rear region), and of which a first end or forward end 137 is nearer to the material moving end of the implement when the auxiliary handle 121 is attached to the implement (the region of the frame leg between the forward end 137 and the high point 127 is the forward region) (FIG. 16, panels A, B, and D). In these embodiments, the secon end 138 and the first end 137 of the leg are in contact with the implement handle shaft 5. In preferred embodiments, the arch is not symmetrical, such that the curve of the single member from the first end 137 or of the forward region increases to a high point 127 (or high region), from which it then rapidly curves downward such that the portion from the high point 127 to the second end 138 (or the rear region) is about perpendicular to the implement handle shaft 5. Thus, the length of the frame from the first end 137 to the high point 127 (or the length of the forward region) is greater than the length of the frame from the high point 127 to the second end 138 (or the length of the rear region). In further preferred embodiments, the arch is concave with respect to the implement handle shaft. In these embodiments, either or both the forward region and the rear region of the single leg 136 may be curved or essentially straight along the majority of the length of the region. The forward end 137 of the single leg 136 comprises means for contacting the forward region to the handle shaft 5; in some embodiments, this contact means is a foot 140, which contacts the implement handle shaft 5 nearer the shovel or fork end 8. The rear end 138 of the single leg 136 comprises means for contacting the rear end 138 of the single leg 136 to the handle shaft 5; in some embodiments, such means is a foot 135 that contacts the implement handle shaft 5 nearer the free end 7.

In other embodiments, the arched frame of an auxiliary handle of the present invention comprises two legs, of which the first member or leg is a forward leg 123 and of which the second member or leg is a rear leg 125 (FIG. 16, panel C). In this embodiment, the second end of both the forward leg 103 and the rear leg 105 meet at an intersection at a high point 127 to form an arch, and neither second end extends beyond the other second end to form a free or handle end. Thus, in this embodiment, a hand grip 129 is attached at the intersection of the forward leg 123 and the rear leg 125. The first end 131 of the forward leg 123 comprises means for contacting the forward leg 123 to the handle shaft 5; in some embodiments, this contact means is a foot 132, which contacts the implement handle shaft 5 nearer the shovel or fork end 8. The first end 133 of the rear leg 125 comprises means for contacting the rear leg 125 to the handle shaft 5; in some embodiments, such means is a foot 134 that contacts the implement handle shaft 5 nearer the free end 7.

In this aspect of the present invention, where the auxiliary handle 121 comprises an arched frame, a hand grip 129 is attached to the high point 127 of the frame. Although various configurations of the hand grip 129, and various angles of attaching the hand grip 109 to the intersection 107, are contemplated, in the embodiment illustrated in FIG. 16, the hand grip 129 is an open oval in shape, and attached at an angle of about 45 degrees toward the forward leg 123 and relative to the rear leg 125. The hand grip 129 may be formed integrally to the high point 127, or it may be separately formed and attached to the high point 127. When separately attached, the hand grip 129 is preferably fixedly attached, such as by a threaded connection, by glue or welding, or by fasteners such as bolts, nails, screws, staples or pins. The hand grip 129 may further comprise a texturized gripping surface; the gripping surface may be made of a comfortable material such as rubber or foam. The advantages of an oval hand grip are believed to be the same as those described above.

The single leg 136, or the forward leg 123 and rear leg 125 are preferably tubular in shape, of a diameter similar to those found in the handle shafts 5 of the implements to which the auxiliary handle 121 may be attached. The forward leg 123 is fixedly attached to the rear leg 125 in an appropriate arch such that the rear leg 125, or rear portion of a single leg 136, is about perpendicular to the handle shaft 5 of the implement; various degrees of curvature are contemplated for the forward leg 123 or forward section of a single leg 136. The forward leg 123 and rear leg 125 may be connected integrally, or they may be separately formed and attached securely together, such as by a threaded connection or by welding or glue.

In other embodiments, the forward leg 123 and rear leg 125 are connected via a junction box 120, which is thus located at the high point 127, as shown for example in FIG. 16, panel C; in yet other embodiments, the single leg 136 is strengthened by a junction box 120, which is generally located at the high point 127. Various configurations are contemplated for a junction box 120; in some embodiments, a junction box 120 is additional strengthening material provided at the high point 127, and in other embodiments, a junction box 120 is a separate component. The advantages of a junction box 120 are believed to be the same as described above for an angled frame.

In particular embodiments, an arched frame further comprises a cross piece 139, which connects the forward leg 123, or forward region of a single leg 136, with the rear leg 125, or rear region of a single leg 136. The cross piece 139 is attached to the forward leg 123, or forward region of a single leg 136, and to the rear leg 125, or rear region of a single leg 136, at some point between and including the ends of the leg(s) in contact with the implement handle shaft 5 and the high point 127. Generally, the cross piece 139 is about parallel to the implement handle shaft 5 when the auxiliary handle 121 is attached to an implement handle shaft 5, although other relationships are contemplated. The cross piece 39 may be integral to the leg(s) of the arched frame, or it may be separate and connected to the leg(s) by well known means, such as by welding, threaded connections, bolts, or adhesives. The cross piece 39 may be of the same diameter and general shape as the leg(s) of the arched frame, or it may be different, for example of a smaller diameter.

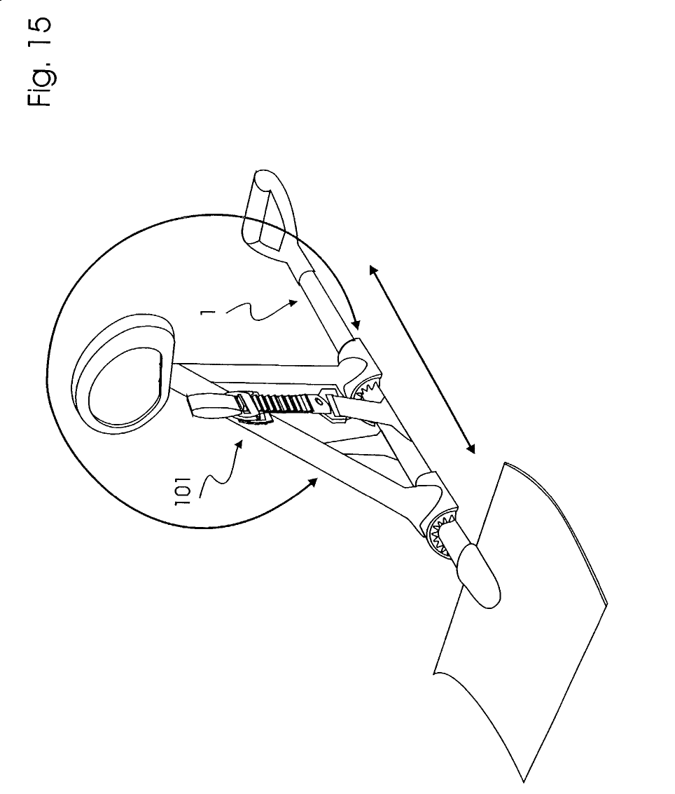

In some embodiments of the auxiliary handle 101 comprising an angled frame and auxiliary handle 121 comprising an arched frame described above, the means to attach auxiliary handles 101 and 121 to an implement handle shaft 5 comprise a belt 118, where the belt 118 slides under the implement handle shaft 5 and is attached to the frame of auxiliary handle 101, 121. The attachment means also comprise means to tighten the belt 118, and means to attach the belt 118 to the auxiliary handle 101, 121, wherein the belt 118 can be tightened to provide sufficient pressure to attach the auxiliary handle 101, 121 to the implement handle shaft 5 such that the auxiliary handle 101, 121 does not rotate around and does not slide along the implement handle shaft 5 when in use. Preferably, the belt 118 can also be loosened sufficiently to allow the auxiliary handle 101, 121 to slide around and along the implement handle shaft 5, as shown in FIG. 15. Sliding along the implement handle shaft 5 allows the position of the auxiliary handle 101, 121 to be adjusted along the implement handle shaft 5, thus achieving, for example, the greatest comfort and efficiency for any particular user. Sliding or rotating around the implement handle shaft 5 also allows the auxiliary handle 101, 121 to be moved into a plane parallel to the shovel blade or fork tines for greater compactness during transportation or storage.

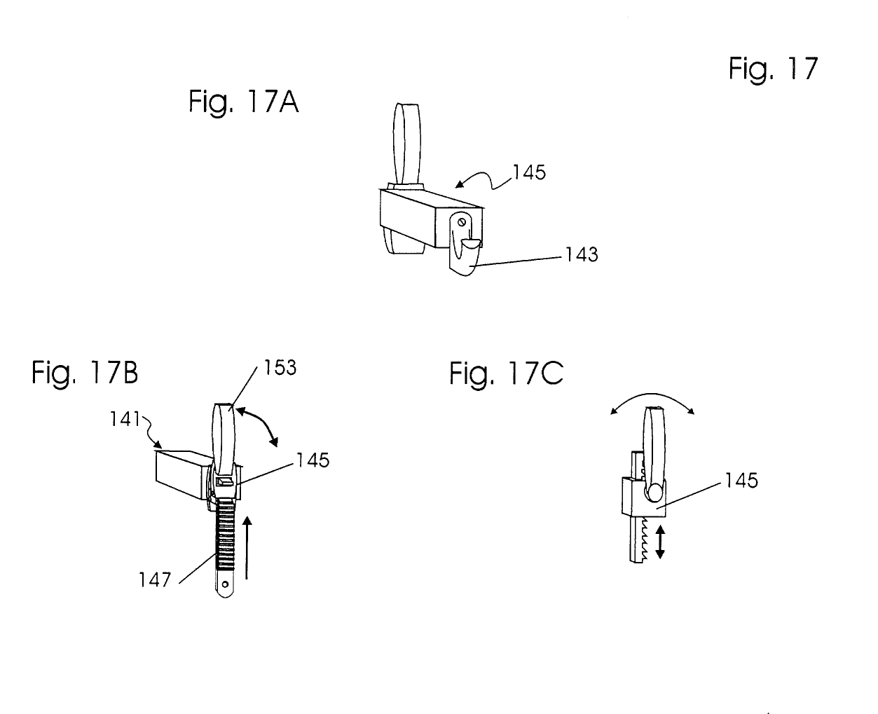

In some embodiments, the means to attach a belt 118 to the frame of an auxiliary handle is a hook-type fitting 143; the fitting 143 may be located on the frame itself, or it may be located on a belt assembly block 143, as shown in FIG. 17. In embodiments in which the means to tighten the belt 118 is located on the frame or a belt assembly block, the auxiliary handle further comprises means to attach and tighten the belt; in some embodiments, this means is a ratchet fitting 145. In these embodiments, the hook-type fitting 143 is on one side of a forward leg or forward portion of the frame of an auxiliary handle, or on one side of a belt assembly block 143, and the ratchet fitting 145 is on the other side of the forward leg or forward portions of the frame of an auxiliary handle, or on the other side of a belt assembly block 143. Two different exemplary ratchet fittings are shown in FIG. 17. In these embodiments, one end of the belt 118 comprises a loop or other configuration that slips over the hook-type fitting 143; the other end of the belt 118 terminates in or is attached to a serrated or indented portion 147 that works with a ratchet fitting 145. The serrated or indented portion 147 is passed up through the ratchet fitting 145. In the embodiment shown in FIG. 18, the forward leg 103 is configured to receive the belt assembly block 141, such that the forward leg 103 comprises a slot 149 of the same outward configuration of the belt assembly block 141 such that the belt assembly block 141 can fit snugly into the slot 149. The auxiliary handle further comprises a latch 151 which can rotate over the slot 149 to keep the belt assembly block in place, and rotate away from the slot 149 to allow the belt assembly block 141 to be removed from or placed into the slot 149. When in use, the belt 118 passes underneath the implement handle shaft 5; in some embodiments, the surface of the belt 118 in contact with the implement handle shaft 5 comprises an anti-slip material.

Use of a belt assembly block 141 allows reversal of the sides on which a ratchet fitting is located, thus accommodating right-handed and left-handed implement users. As shown in FIG. 18 and described above, the ratchet fitting 145 and hook-type fitting 143 are on opposite ends of a belt assembly block 141 that “drops” into a slot 149 on the top of the forward leg 103 of an auxiliary handle frame. In these embodiments, the belt assembly block 141 is held in place by a simple latch 151, where the latch does not take any load as the belt 118 is tightened. To reverse the side of an auxiliary handle on which the ratchet fitting 145 is located, the belt 118 is unhooked from the hook-type fitting 143, the latch 151 is rotated away from the belt assembly block 141, the belt assembly block 141 is lifted out of the slot 149 and rotated 180 degrees and then replaced into the slot 149, the latch 151 is rotated back over the belt assembly block 141, and the belt 118 reattached to the hook-type fitting 143. Because the belt assembly block is located on top of the forward leg, it is contemplated that this configuration for reversing the side of an auxiliary handle on which a ratchet fitting is located is particularly suited auxiliary handles with a straight or slightly arched forward leg.

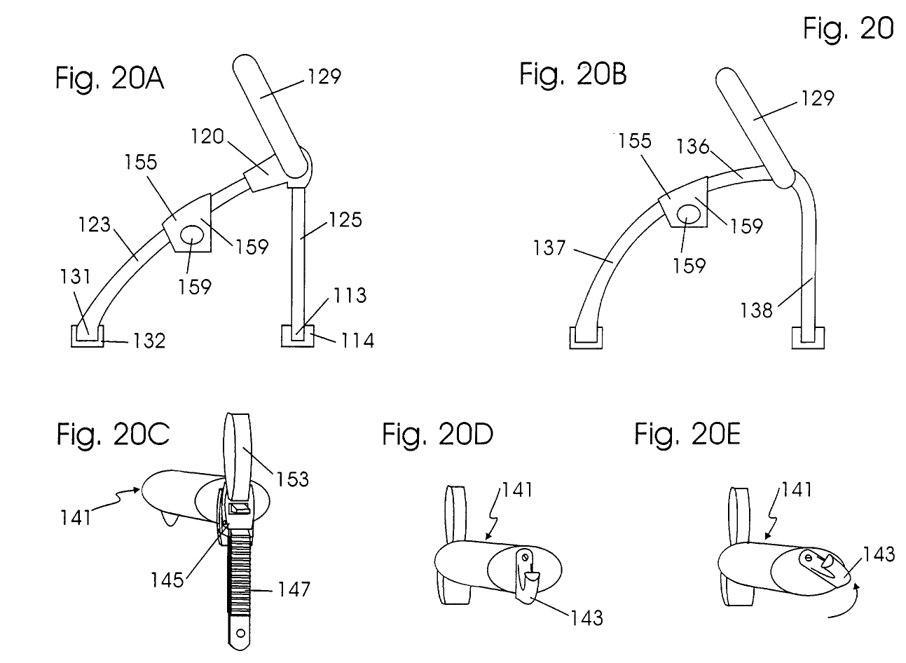

Other embodiments for reversing the side on which a ratchet fitting 145 is located are shown in FIG. 20, where a belt assembly block 141 fits through the lower portion 157 of a lateral sleeve 155. A lateral sleeve 155 is an element which fits over a leg or a cross piece when present such that it extends below the leg or cross piece, forming a lower portion 157. The lower portion 157 may be configured to receive a belt assembly block 141; in some embodiments, the configuration is an opening 159 of sufficient size and shape into which a belt assembly block 141 can fit. In other embodiments, a lateral sleeve is an integral member of a leg or cross piece. The lateral sleeve 155 may further comprise at least one latch which prevents a belt assembly block 141 from sliding out when placed into the opening 159. To reverse the side of an auxiliary handle on which the ratchet fitting 145 is located, the belt 118 is unhooked from the hook-type fitting 143, the latch is moved such that it not longer restrains the belt assembly block 141, the belt assembly block 141 is removed from the lateral sleeve opening 159, rotated 180 degrees, and then replaced into the lateral sleeve opening 159, the latch is moved such that it securely restrains the belt assembly block 141, and the belt 118 reattached to the hook-type fitting 143. Because the belt assembly block 141 is located below a forward leg 123 or cross piece 139 when present, it is contemplated that this configuration for reversing the side of an auxiliary handle on which a ratchet fitting is located is best suited to auxiliary handle frames with an arched forward leg.

When the ratchet fitting 145 is operated, contact between the auxiliary handle and the implement handle shaft 5 as the belt 118 is progressively increased, resulting in attachment of the auxiliary handle to the implement handle shaft 5. Sufficient tightening of the belt 118 decreases any tendency of the either leg of the auxiliary handle frame to lift away from the implement's handle shaft when the implement is under a load. Sufficient tightening of the belt 118, an in some embodiments aided by anti-slip material on the surface of the belt 118 in contact with the implement handle shaft, results in development of increasing resistance to twisting, spinning, or rotating of the implement handle shaft 5 within the belt 118 when the tool's working surface (such as one outer edge of a snow shovel hooked underneath a rock) generates a torsion load.

In the exemplary, ratchet fitting 145 shown in FIG. 17B, the ratchet is tightened by moving the ratchet's grip or lever 155 out away from the ratchet fitting's body and then back in towards it. In the exemplary ratchet fitting 145 shown in FIG. 17C, the ratchet is tightened by moving the ratchet's grip or lever 155 forward and backward (parallel to the ratchet fitting's body). Different types of ratchets may be more suitable or comfortable for different users.

To attach or detach an auxiliary handle from an implement handle shaft 5, one end of the belt 118 is first detached from the auxiliary handle. This is accomplished by removing all tension off the belt 118 by lifting the lever 155 on the ratchet fitting 145, thus disengaging the ratchet fitting from the serrated/indented portion 147 of the belt 118 and allowing the belt 118 to go slack. One end of the belt 118 is then detached from the auxiliary handle frame, so that the belt 118 can drop down and the auxiliary handle be removed from the implement handle shaft 5. Although the serrated or indented portion 147 of the belt 118 could be removed from the ratchet fitting 145, as for example if the other end of the belt is fixedly attached to the auxiliary handle frame, it is preferably to slip the belt 118 off the hook-type fitting 143.

Attachment of an auxiliary handle to an implement handle shaft with a belt 118 and a ratchet fitting 145 provides several advantages over attachment with clamps. These include a single point attachment by the belt/ratchet combination, resulting in one attachment mechanism to work with instead of two. Another is that in combination with the ratchet mechanism's lever/grip, the ratchet mechanism provides an easier and effective way to generate considerable “grip” on the an implement's handle shaft. Moreover, the ratchet ever/grip can utilize generally greater hand strength, instead of generally lesser finger-strength utilized with clamps. Furthermore, a ratchet mechanism, because it operates in discreet steps, provides an easier method to tighten the attachment of the auxiliary handle to the implement handle shaft. In addition, use of a belt provides additional surface area in contact with an implement handle shaft, which is believed to provide increased resistance to twisting of the implement handle shaft when attached to an auxiliary handle.

Because it might be possible to over-tighten a belt with a ratchet fitting, resulting in potential structural damage to an auxiliary handle or to an implement handle, in some embodiments, an auxiliary handle comprises a belt which further comprises at least two sections of a velcro-like material at one or both ends or at other areas within the belt, where the velcro-like material holds the belt together, or holds a shorter stretch of belt together. The amount of the velcro-like material is such that above a certain amount of tension, the sections of velcro-like material separate from each other, resulting in the belt separating or lengthening, thus preventing structural damage and/or failure. In other embodiments, an auxiliary handle comprises a ratchet fitting comprising a grip that is fairly rigid until a certain amount of tension has been applied, but that bends more and more as additional tension has been applied, thus providing feedback to the user that the belt is overly tightened. In yet another embodiment, an auxiliary handle comprises a ratchet fitting which will not tighten beyond a certain point.

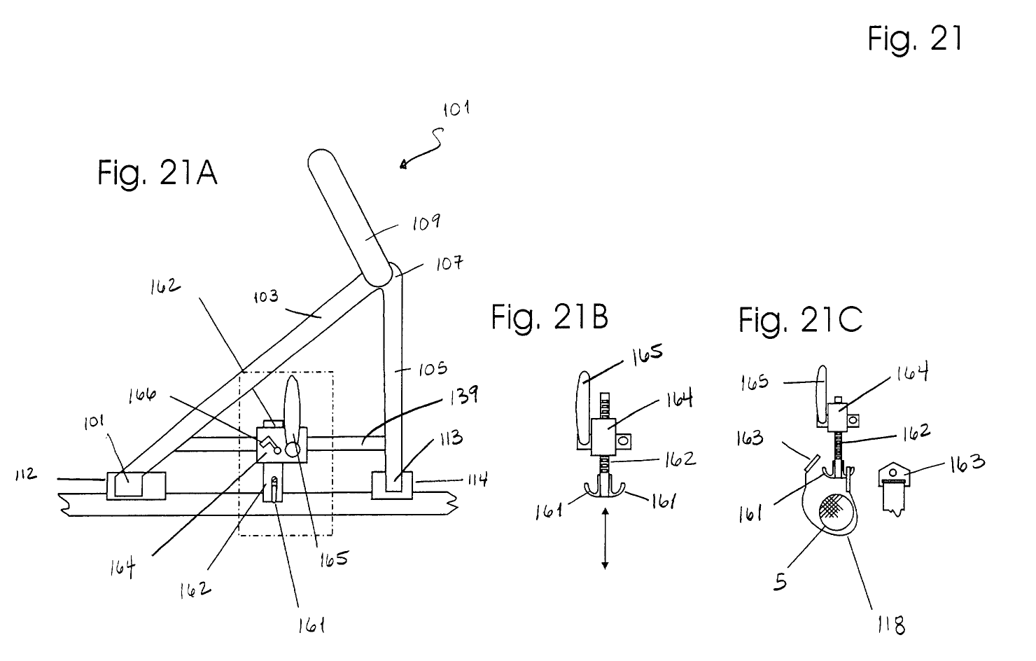

In some embodiments in which means to attach auxiliary handles 101 and 121 to an implement handle shaft 5 comprise a belt 118, where the belt 118 slides under the implement handle shaft 5 and is attached to the frame of auxiliary handle 101, 121, the means to tighten the belt 118 is attached to the auxiliary handle 101, 121 and further comprises means to attach the belt 118, where the means comprises a mechanism to jack the belt 118 up toward the auxiliary handle frame. In these embodiments, at least one end of the belt 118 is detachably attached to the tightening means. The tightening means may be attached or mounted to the forward leg 123 or forward region of a single leg 136, or it may be attached or mounted to a cross-piece 139. Any suitable attachment of the tightening means is contemplated. In one embodiment shown in FIG. 21, the belt 118 is detachably attached to two hooks 161 which are located on either side at the bottom end of a slide 162; the belt 118 may comprise holes or loops which fit over the hooks, where the loops may be fashioned from the belt end or separately attached to the belt (an exemplary loop 163 is shown in FIG. 21 C). The slide 162 is notched to fit into a ratchet mechanism 164 which comprises a tightening lever 165; the ratchet mechanism 164 may be configured such that the tightening lever 165 can be removed from one side and inserted into the other side of the ratcheting mechanism 164. When the tightening lever 165 is engaged, the slide 162 moves upward, pulling up and tightening the belt 118 and securely fastening or attaching or engaging the auxiliary handle 101, 121 to an implement handle shaft 5. The ratchet mechanism 164 further comprises means for releasing the lever; such means include a ratchet release lever 166.

An auxiliary handle of the present invention may be fabricated from any suitable material. Preferably, such material is strong and light weight. Different parts of the handle may be fabricated from the same or different materials. Different parts of the handle may be fabricated integrally or separately and subsequently attached together. The parts of the handle may also be fabricated of a single material, or of different materials in multiple layers, or of a single material in multiple layers. Typical attachment means for the different parts of the frame of an auxiliary handle include but are not limited to threaded connections, welding, gluing, staples, nails, screws, and pins. Typical materials include wood, aluminum, plastic, and fiberglass. The leg members of the auxiliary handle are preferably tubular in shape; they may be solid or hollow. If they are hollow, they may be re-enforced by an internal structure or scaffolding, or by structures or scaffolding within the material from which the leg members are fabricated. Bolts 37 and nuts 49 and bolt caps 55 used to fasten the clamps together may also fabricated of different types of materials; particularly suitable materials include metal and plastic. Threaded inserts for bolts 37, when used in particular embodiments, may be fabricated of the same or of a different material from the bolts; preferably, plastic threaded inserts are used with plastic bolts. Belts are fabricated from suitable materials, such as heavy-duty nylon. Means to attach belts to a frame of an auxiliary handle, and means to tighten a belt, are also fabricated from suitable materials; such materials include wood, aluminum, plastic, fiberglass, and metal.

An auxiliary handle of the present invention may be used with any long handled manual material moving implement. Such implements include but are not limited to snow shovels, grain shovels, and other types of shovels, spades, hoes, rakes, lawn edgers, garden forks, push brooms, mops, and pitch forks.

To use an auxiliary handle of the present invention with long-handled implements as described above, the user positions an auxiliary handle upon the top of an implement handle shaft 5 anywhere along the length thereof but preferably near the blade or fork end 8 so that the user can generate leverage to lift the front end 8 of the tool. With embodiments in which the means for attaching the auxiliary handle 11,61 to the implement handle shaft 5 are clamps, the auxiliary handle 11,61 is positioned with the concave surfaces 46 of the upper clamp housings 33 being mounted along the upper surface 6 of the implement handle shaft 5. The user then fastens the auxiliary handle 11,61 to the handle shaft 5 by attaching the lower damper bars 35 to the upper clamp housings 33, thereby clamping the auxiliary handle 11, 61 to the handle shaft 5. With embodiments in which the means for attaching the auxiliary handle 101, 121 to the implement handle shaft 5 is a belt 118, the auxiliary handle 101, 121 is positioned with the first ends of the forward legs or forward portions being mounted along the upper surface 6 of the implement handle shaft 5. The user then fastens the auxiliary handle 101, 121 to the handle shaft 5 by passing the belt 118 beneath the implement handle shaft 5, attaching the free end of the belt 118 to the hook type fitting 143 on the frame of the auxiliary handle, which in some embodiments is attached to a belt assembly block 141, tightening the belt 118, as by the ratchet fitting 145, thereby securely attaching the auxiliary handle 101, 121 to the handle shaft 5.

To use an auxiliary handle of the present invention, such as auxiliary handle 11, 61, with the implement, the user grasps the free end 7 of the implement handle shaft 5 with one hand, and grasps the auxiliary handle 11, 61 at the free end 17,67 or hand grip 19,69 of the handle member 13, 63, while standing to one side of the implement. The user is then able to pull up on the auxiliary handle 11,61 and simultaneously push down or forward on the implement handle shaft 5, and due to the leverage provided by the auxiliary handle 11,61, is able to move the desired material with greater ease and less strain. Because the hand grasping the auxiliary handle 11,61 is both closer to the user and further from the ground or material to be moved by the implement than it would be in the absence of the auxiliary handle 11,61, the user is able to manipulate the implement and move the material with less stooping and bending than would be required without the auxiliary handle 11,61. Use of other embodiments of an auxiliary handle of the present invention are similar.

In addition, an auxiliary handle of the present invention may be used with very long handled implements, such as snow rakes and tools for grooming the surface of wet concrete. The pattern of use of these implements is to position the implement's working surface some distance away from the user while holding the working surface aloft, then to lower the working surface and pull it towards the user. Thus, the user holds the working (or material moving) end of the implement aloft and positions it over the surface to be worked. The user then lowers the working end of the implement onto the surface to be worked. The user pulls the working end of the implement backwards, and/or walks backwards, thus moving the working end of the implement over the surface to be worked. Use of an auxiliary handle of the present invention provides increased leverage and control of the working end of such implement. Auxiliary handle 61 offers the additional advantage that it may be “turned around,” or attached to the lower surface 4 of the implement handle shaft 5; the angle of the handle member 63 and of the hand grip 69 if present keeps the user's wrist at a proper angle for using the auxiliary handle 63 in this “turned around” position.

Various modifications and variations of the described auxiliary handle of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those of ordinary skill in the art are intended to be within the scope of the following claims.

What is claimed is:

1. A detachable auxiliary handle for use with a long-handled manual material moving implement comprising:
a handle leg member having a first end and a second end, wherein the first end comprises means to contact the member to a handle shaft of a the implement and wherein the second end is a free end;
a brace leg member having a first end and a second end, wherein the first end comprises means to contact the member to a handle shaft of the implement such that the brace leg member is approximately perpendicular to the handle shaft, and wherein the second end is fixedly attached to the handle leg member slightly down from the free end of the handle member to form an approximately 45 degree angle with the handle leg member; and
means to detachably attach the auxiliary handle to the implement handle shaft.

2. The auxiliary handle of claim 1, wherein the handle leg member further comprises a hand grip on the free end.

3. The auxiliary handle of claim 1, wherein the means to detachably attach the auxiliary handle to the implement handle shaft comprise a clamp at the first end of the handle leg member and a clamp at the first end of the brace leg member, wherein the clamp comprises two main components, an upper clamp housing and a lower damper bar, and wherein the two components of the clamp are fastened with bolts, and further wherein the lower damper bar comprises means by which the damper bar can be pivoted around one bolt while a second bolt remains in place, allowing the auxiliary handle to be removed from the implement handle shaft.

4. The auxiliary handle of claim 1, wherein the means to detachably attach the auxiliary handle to the implement handle shaft comprise a clamp at the first end of the handle leg member and a clamp at the first end of the brace leg member, wherein the clamp comprises two main components, an upper clamp housing and a lower damper bar, and wherein the two components of the clamp are fastened with bolts, and further wherein a surface of the upper clamp housing in contact with the implement handle shaft, a surface of the lower damper bar in contact with the implement handle shaft or both surfaces further comprise nubby grippers.

5. The auxiliary handle of claim 1, wherein the means to detachably attach the auxiliary handle to the implement handle shaft comprise a belt, such that the belt passes below the implement handle shaft, means to attach the belt to the auxiliary handle, and means to tighten the belt.

6. A detachable auxiliary handle for use with a long-handled manual material moving implement comprising:
a handle leg member having a first end and a second end, wherein the first end comprises means to contact the handle leg member to a handle shaft of a the implement such that the handle leg member is approximately perpendicular to the handle shaft and wherein the second end is a free end;
a brace leg member having a first end and a second end, wherein the first end comprises means to contact the brace leg member to the handle shaft of the implement, and wherein the second end is fixedly attached to the handle leg member slightly down from the free end of the handle member to form an approximately 45 degree angle with the handle leg member; and
means to detachably attach the auxiliary handle to the implement handle shaft.

7. A detachable auxiliary handle for use with a long-handled manual material moving implement comprising:
a first leg member having a first end and a second end, wherein the first end comprises means to contact the first end to a handle shaft of the implement such that the first leg member is approximately perpendicular to the handle shaft;
a second leg member having a first end and a second end, wherein the first end comprises means to contact the first leg member to the handle shaft of the implement, and wherein the second end is fixedly attached to the second end of the first leg member at an intersection to form an approximately 45 degree angle with the first leg member;
a hand grip attached to the intersection of the two legs; and
means to detachably attach the auxiliary handle to the implement handle shaft.

8. A detachable auxiliary handle for a long-handled manual material-moving implement comprising:
a single leg having a first end and a second end, wherein the first end comprises means to contact the first end to a handle shaft of the implement and wherein the second end comprises means to contact the second end to the implement handle shaft, and wherein the leg is curved so as to form an arch between the first and the second end;
a hand grip attached to a high point in the arch; and
means to detachably attach the auxiliary handle to the implement handle shaft.

9. A detachable auxiliary handle for use with a long-handled manual material moving implement comprising:
a first leg member having a first end and a second end, wherein the first end comprises means to contact the first end to a handle shaft of the implement such that the first leg member is approximately perpendicular to the handle shaft;
a second leg member having a first end and a second end, wherein the first end comprises means to contact the first leg member to the handle shaft of the implement, and wherein the second end is fixedly attached to the second end of the first leg member at an intersection to form an approximately 45 degree angle with the first leg member;
a hand grip attached to the intersection of the two legs; and
means to detachably attach the auxiliary handle to the implement handle shaft, wherein at least one of the legs is curved to form an arch in the auxiliary handle.
